(19) United States
(12) Patent Application Publication
(10) Pub. No.: US 2007/0202036 A1
(43) Pub. Date: Aug. 30, 2007

(54) Production Of Barium Titanate Compounds

(76) Inventors: Nathalie Jongen, Preverenges (CH); Andrea Testino, Genova (IT)

Correspondence Address: Nathalie Jongen;TechPowder SA, Parc Scientifique De L'Epfl, Building C, Lausanne, CH-1015, CH

(21) Appl. No.: 10/599,668

(22) PCT Filed: Apr. 7, 2005
(86) PCT No.: PCT/IB05/01003

§ 371 Date: Oct. 5, 2006

(30) Foreign Application Priority Data
Apr. 7, 2004 (EP) 04405211.6

(51) Int. Cl. C01B 13/14

(52) U.S. Cl. 423/593.1; 423/598; 423/594.16

(57) ABSTRACT

An ultrafine powder of barium titanate including solid solutions and doped compounds that meets up to specific characteristics is produced by method comprising two main steps. The first step is a reaction, typically in a Segmented Flow Tubular Reactor, between reactants to produce cubic-structure barium titanate composed of non-agglomerated ultrafine particles having a shape of given aspect ratio, usually a generally spherical shape, of low density corresponding at most to 90% of the intrinsic density, all particles being smaller than 1 micron and having a narrow particle size distribution and wherein the ratio of Ba:Ti including substitutents and dopants is very close to the ideal stoichiometry. This is followed by subjecting the powder produced in the first step to a second stage solvothermal post treatment typically in an autoclave at temperature less than 400° C. to convert the cubic-structure particles of low density to ultrafine tetragonal particles of increased density corresponding to at least 90% of the intrinsic density while maintaining the same aspect ratio, and maintaining the size of all particles below 1 micron, the narrow particle size distribution span, and the given ideal stoichiometry. The produced particles can have a non-spherical facetted shape such as cube-like.

### FIELD OF THE INVENTION

The invention relates to the production of ultrafine powders of barium titanate BaTiO₃ as well as solid solutions and doped compounds derived from barium titanate.

### BACKGROUND OF THE INVENTION

Barium titanate is an important material for the electronic industry due to its dielectric and piezoelectric properties which make it suitable for many applications such as multilayer ceramic capacitors, positive temperature coefficient (PTC) thermistors, piezoelectric actuators, passive memory storage devices, acoustic transducers, and in electroluminescent panels.

The market for multilayer ceramic capacitors (MLCC) continues to demand smaller size components for a given capacitance or increased capacitance within a given part design. The capacitance per unit volume for an MLCC can be derived as:
Cᵥ=nK₀K/t²
where Cᵥ is the capacitance per unit volume of the active part of the capacitor, n is the number of active layers, K₀ is the permittivity of free space (a constant), K is the dielectric constant of the ceramic and t is the active thickness separating the active layers. In a given MLCC design with a fixed active volume Cᵥ has to be increased by:
(1) Using a ceramic with higher K
(2) Making thinner layers, t
(3) Using more layers, n, in the component
(4) A combination of the above

Option (2) is an effective way to increase Cᵥ and thinner layers of both ceramic and electrode are required to realize the benefit of more layers (3).

For use in smaller size MLCC as described above, the following characteristics are required for barium titanate powder:
Small Particle Size
Isotropic shape
Narrow particle size distribution with limited agglomeration
No agglomerates bigger than the thickness of the dielectric layers of the MLCC.
Controlled stoichiometry with ideal Ba/Ti ratio very close to 1
High purity
High density tetragonal phase

Small particle size is required to design MLCC with dielectric layers smaller than 1 micron in thickness. At least 5 pieces of grains are required between the electrodes to ensure long term stability to the final product; therefore fine grains of less than 200 nm are required for a ceramic layer, which is as thin as 1 micron or less. Small particle size also allows sintering at lower temperature than the usual range 1250-1350° C. (this behaviour is also useful when the ceramic is co-fired with palladium-silver alloys or nickel or copper which have a low melting temperature).

A narrow particle size distribution allows achieving porosity free and homogeneous microstructure after sintering the ceramic layer. It is well known that narrow particle size distributions and well-dispersed suspensions are required to manufacture pastes for screen-printing or tape casting. Agglomerates bigger than the thickness of the dielectric layers of the MLCC are detrimental to obtaining adequate MLCC.

Controlled stoichiometry with Ba/Ti ratio close to 1.000 is necessary to obtain excellent electrical properties and well-defined sintering behaviour. The Ba/Ti ratio also affects the sintering temperature. The presence of excess TiO₂, as it forms a eutectic liquid phase with BaTiO₃ at 1332° C., is known to dramatically influence the microstructure development. The presence of secondary phase Ba₆Ti₁₇O₄₀ leads to the degradation of the insulation resistance at high temperature. Decreasing Ba/Ti ratio from 0.999 to 0.993 can lead to grain sizes twice bigger after sintering.

High purity powder is required to control the dielectric properties of barium titanate.

Better dielectric properties are obtained from high-density barium titanate with a tetragonal structure. Tetragonal barium titanate powders have a better sintering behaviour, higher intrinsic density and lead to ceramics with higher dielectric constants than cubic-phase powders. Also, cubic-phase barium titanate produced by the hydrothermal route exhibits a bloating effect when the MLCC is sintered, causing severe cracks and delamination, as a result of the segregation of porosity in the electrode region.

Various methods are used for the production of barium titanate. In order to obtain above mentioned required characteristics, an economically acceptable process or method of production of barium titanate should use low cost equipment and raw material, limit grinding or pulverizing processes, use low temperature, and have short production time.

Traditionally barium titanate is prepared using the solid-state route by ball milling BaCO₃ and TiO₂. The mixture is then heated at a temperature of 900° C. or above. However, BaTiO₃ prepared at high temperature exhibits some drawbacks, such as large particle size, a wide size distribution, and a high impurity content resulting from repetitive calcinations and grinding treatments. Further limitations include the inability to control stoichiometry and crystallinity. Often an undesired secondary phase such as BaTi₂O₅ is produced.

Other techniques, such as precipitation, gas condensation, and sol-gel processing, have been developed to improve size, size distribution, and purity. As an example, the sol-gel processing using metal alkoxides as reactants leads to fine particles but alkoxides are generally too expensive. The oxalate co-precipitation route consisting of precipitation of a mixed barium-titanium oxalate precursor by reaction between a BaCl₂ and TiCl₄ solution and an oxalic acid solution requires heat-treatment (˜700° C.) with the common drawbacks of large particle size, wide particle size distribution and agglomeration.

Hydrothermal synthesis is another wet chemical route to prepare barium titanate. Usually a barium soluble salt (e.g. chloride, nitrate, acetate) or barium hydroxide is used as barium precursor. Titanium is usually provided by titanium dioxide or amorphous titanium hydroxide (prepared by hydrolysing organic or inorganic titanium compounds). Often, NaOH or KOH are used as mineralising agent. The reactants are subjected to high temperatures and pressures in an autoclave. Using amorphous titanium hydroxide generally leads to a wider particle size distribution and agglomerates, and requires higher cost raw materials. Using TiO₂ as precursor leads to a narrower particle size distribution but it is difficult to achieve an adequate Ba/Ti ratio and the necessary longer production time increases the level of agglomeration and the cost of the process. In general in a large hydrothermal reactor it is difficult to ensure homogeneous nucleation conditions within the whole vessel, which in turn induces a wide size distribution.

Another drawback of a hydrothermal synthesis at moderate temperatures is that it leads to cubic-phase barium titanate with a low density. Hydrothermal conditions for producing commercial quantities are usually under maximum temperature of 350° C. and pressures below 100 Mpa, above which conditions are considered severe (Riman et al., Hydrothermal crystallization of ceramics, Ann. Chim. Sci. Mat., 27(6), pp 15-36, 2002). However, in order to obtain a higher density tetragonal phase barium titanate using the hydrothermal process, a temperature of above 400° C. is required (Kajiyoshi et al. “Preparation of tetragonal barium titanate thin film on titanium metal substrate by hydrothermal method”, J. Am. Ceram. Soc., 74, pp 369-74, 1991).

The cubic-phase and lower density of hydrothermally produced barium titanate can be explained because of the existence of lattice defects such as hydroxyls (OH⁻) in small particles. According to Vivekanandan et al., the OH⁻ included in barium titanate particles prepared hydrothermally contribute to the stabilization of a cubic phase at room temperature which is normally observed only at temperatures above the ferroelectric Curie point at 130° C. (Vivekanandan et al, Hydrothermal preparation of Ba(Ti,Zr)O₃ powders, Mater. Res. Bull., 22, pp 99-108, 1986). In a publication by Hennings et al., the authors indicate that tetragonal phase barium titanate is obtained upon heat-treatment above 600° C. (Hennings et al., Characterization of hydrothermal barium titanate, J. Eur. Ceram. Soc., 9, pp 41-46, 1992).

In a later publication, Hennings et al. (Defect chemistry and microstructure of hydrothermal barium titanate, J. Am. Ceram. Soc. 84(1), pp 179-182, 2001) show that for commercial (Cabot Performance Materials, BT4) and self-prepared cubic-phase barium titanate of initial density 5.65±0.05 g.cm⁻³, all OH⁻ are removed upon heat treating above 600° C. as showed by thermogravimetric analysis, but only as of 800° C. the density starts increasing reaching 5.97 g.cm⁻³ at 1000° C. Also in the temperature range 20-400° C., there is a large discrepancy between the theoretical density calculated from the lattice parameters (5.93 g.cm⁻³) and the pycnometric density (5.65 g.cm⁻³). The model involving defects due to the presence of OH⁻ in the structure up to 600° C. however explains the pycnometric density. The lower density of hydrothermal barium titanate is also explained in terms of intragranular porosity which can only disappear with a heat-treatment above 800° C.

However heat-treating barium titanate powders to obtain tetragonal phase (˜600° C.) and a higher density (˜1000° C.) leads to the common drawbacks of larger particle size, wide particle size distribution and agglomeration.

To be noted that recent work reported that hydrothermal tetragonal barium titanate can be prepared at a temperature as low as 240° C. over several days of synthesis however obtaining submicrometer-sized, even millimeter-sized particles (in Xu et al. Tetragonal Nanocrystalline Barium Titanate Powder: Preparation, Characterization and Dielectric Properties, J. Am. Ceram. Soc., 86(1) pp 203-205, 2003). As reported by Asiaie et al. (in Characterization of submicron particles of tetragonal BaTiO₃, Chem, Mater., 8 pp 226-234, 1996) tetragonal barium titanate was obtained after 14 days of hydrothermal treatment at 240° C. As a consequence of the long ageing time, particle growth to 0.5 μm. was observed. Xu et al. (idem, 2003) have reported the preparation of nanometer sized tetragonal barium titanate using the hydrothermal process for 12 hours in a 30 ml vessel; however the TEM picture shows a wide size distribution. No information about the density of those tetragonal barium titanate powders is reported (above cited Xu et al., Asiaie et al.).

EP 1,205,440 describes the preparation of spherical tetragonal barium titanate particles which have an average primary particle diameter (measured by image analysis from electron micrographs) from 0.05 to 0.5 μm and a fairly even particle size distribution by a process which involves adding an aqueous barium salt solution to a titanium hydroxide solution in the presence of a carboxylic acid to produce starting barium titanate particles by ageing usually at 70° C. for 2 hours. When the ageing time is less than 0.5 hour, a sufficient effect may not be obtained. These particles are then hydrothermally treated to obtain spherical cubic-phase barium titanate particles which are calcined at temperatures from 500 to 1,200° C. to transform the spherical cubic-phase barium titanate particles into spherical tetragonal barium titanate particles.

U.S. Pat. No. 5,445,806 describes the preparation of barium titanate obtained by a wet reaction (including coprecipitation, hydrolysis, hydrothermal or thermal reaction) from an aqueous solution, followed by calcining at temperature of at least 1000° C. for several hours to produce tetragonal barium titanate powder of average primary particle size (measured by image analysis) below 0.3 μm, particularly 0.05 to 0.25 μm and with uneven shape (see its FIG. 2).

The Paper “Aqueous Synthesis of Submicron and Nanometre BaTiO₃ Particles in a Segmented Flow Tubular Reactor (SFTR)” Buscaglia et al, CIMTEC 2003—10^{th} International Ceramics Congress—Part A, describes the production of high quality barium titanate powder using the SFTR technology. The resulting powders show improved quality in comparison to batch synthesis. Fine powders with tailored size (about 30 nm) could be obtained, that show a certain degree of agglomeration. It has been experimentally verified that these particles are of cubic structure and have high sodium content.

U.S. Pat. No. 4,764,493 describes the preparation of barium titanate from a suspension or a solution at a temperature below the boiling point of the solvent for at least 48 hours to obtain barium titanate having a density of at least 5.7 g.cm⁻³, a mean primary particle size of about 0.09-0.2 μm with a geometric standard deviation of 30% and a substantially spherical shape.

U.S. Pat. No. 6,205,015 describes the preparation of dielectric ceramic components and the method for producing such devices using a tetragonal barium titanate powder with the following characteristics: the amount of hydroxyl groups in the crystal lattice is 0.1 wt. % to about 1 wt. %, the maximum particle size is about 0.5 μm or less and the average particle size is about 0.1-0.3 μm, individual particles of the barium titanate powder comprise a low-crystallinity portion and a high-crystallinity portion, and the diameter of the low-crystallinity portion is less than about 0.65 times the particle size of the powder. The related U.S. Pat. No. 6,303,529 describes the preparation of dielectric ceramic components using a tetragonal barium titanate powder with the following characteristics: the amount of hydroxyl groups in the crystal lattice is 2.0 wt. % or less the maximum particle size is about 0.3 μm or less and the average particle size is about 0.05-0.15 μm, individual particles of the barium titanate powder comprise a low-crystallinity portion and a high-crystallinity portion, and the diameter of the low-crystallinity portion is about 0.5 times or more the particle size of the powder. Such barium titanates can be obtained by thermally treating barium titanate powder which is produced through a wet synthesis method such as a hydrothermal synthesis method, a hydrolysis method, or a sol-gel method. There may also be employed a solid phase synthesis method in which a carbonate, an oxide, etc of elements constituting the barium titanate powder are mixed and thermally treated. As discussed above, these processes all lead to disadvantages.

EP 1,013,608 describes the chemical preparation of a barium titanate powder from an aqueous solution with an average primary particle size (determined by image analysis) ranging from 0.1 to 1.0 μm with a CV value (standard deviation of the particle size/the average particle size of the particle size distribution) of 21 to 40% (the corresponding CV value of the inventive examples reported below is from 11 to 15%). No indication of the particle shape is provided.

U.S. Pat. No. 6,485,701, EP 1,264,809 and EP 1,130,004 describe the manufacturing method for an oxide having a perovskite structure by a solid state reaction of a metal oxide powder and a metal carbonate powder, which can be used to produce tetragonal barium titanate with low OH content, with average primary particle diameter (determined by image analysis) in the range 0.03 to 0.2 μm. The solid state reaction requires temperatures above 900° C. This leads to the formation of strong agglomerates necessitating milling which leads to a wide particle size distribution.

US 2003/0044347 and EP 1,415,955 describe the preparation of tetragonal barium titanate and barium titanate based compounds by aqueous reaction up to boiling point followed by crystallization of the BaTiO₃ at 600° C. or above for several hours. The product's BET specific surface area is between 0.1 m²/g and 9.7 m²/g corresponding to sizes from about 10 to about 0.1 μm.

U.S. Pat. No. 4,863,883 describes substantially spherical powders of doped barium titanate compositions prepared by hydrothermal synthesis from titanium dioxide and hydroxides at temperatures up to 225° C. Those powders have the following characteristics: their median primary particle size as determined by image analysis in the range of 0.05 to 0.4 μm, the primary particle size distribution, as determined by image analysis, has a quartile ratio (QR=d₇₅/d₂₅) less than or equal to 1.5, the median primary particle size, as determined by image analysis and by sedimentation, agree within a factor of two, the particle size distribution, as determined by sedimentation, has a quartile ratio (QR=d₇₅/d₂₅) less than or equal to 2.0, and the particle size, as determined by image analysis and by surface area, agree within a factor of two. No indication about the density and the crystal structure of the compounds is provided.

U.S. Pat. No. 4,829,033 describes substantially spherical powders of barium titanate based dielectric compositions prepared by heating suspensions containing the hydrous tetravalent oxides with selected divalent oxides or hydroxides to which a barium hydroxide solution is added before heating to a higher temperature. Those powders have the following characteristics: their median primary particle size as determined by image analysis in the range of 0.05 to 0.4 μm, the primary particle size distribution, as determined by image analysis, has a quartile ratio (QR=d₇₅/d₂₅) less than or equal to 1.5, the median primary particle size, as determined by image analysis and by sedimentation, agree within a factor of two, the particle size distribution, as determined by sedimentation, has a quartile ratio (QR=d₇₅/d₂₅) less than or equal to 2.0. No indication about the density and the crystal structure of the compounds is provided.

### SUMMARY OF THE INVENTION

In a main aspect, the invention provides a method of producing a powder of barium titanate, including solid solutions and doped compounds thereof, which powder is composed of non agglomerated ultrafine particles of tetragonal structure, of high density corresponding to at least 90% of the intrinsic density of a large crystal of the corresponding compound, whose individual particles have an isotropic shape of given aspect ratio. All particles are to be smaller than 1 micron and have a particle size distribution measured by sedimentation characterized by a span (dᵥ₉₀−dᵥ₁₀)/dᵥ₅₀ less than 1, where dᵥ₉₀ refers to a value such that 90% of the powder volume is made of smaller sizes, dᵥ₁₀ refers to a value such that 10% of the powder volume is made of smaller sizes, and dᵥ₅₀ refers to the volume median diameter such that 50% of the powder volume is made of smaller sizes, and wherein the ratio of Ba:Ti including their substitutents and dopants is very close to ideal stoichiometry.

The method according to the invention for producing powder to this specification comprises two main steps:

(a) a first stage reaction between reactants composed of barium and titanium and optional selected substitutents and dopants by preparing at room temperature a liquid-containing reaction mixture and subjecting the reaction mixture to reaction temperatures in the range 80° C., preferably 85° C., to boiling temperature, at a pressure of 1 bar, for a reaction period up to 20 minutes to produce a powder of barium titanate composed of non-agglomerated ultrafine particles having a shape of the above-mentioned given aspect ratio, and cubic structure, of low density corresponding at most to 85% or 90% of said intrinsic density, all particles being smaller than 1 micron and having a particle size distribution span (dᵥ₉₀−dᵥ₁₀)/dᵥ₅₀ less than 1, and wherein the ratio of Ba:Ti including their substitutents and dopants is very close to ideal stoichiometry; followed by

(b) subjecting the powder of cubic structure produced in step (a) to a second stage solvothermal post treatment at a temperature less than 400° C. to convert the particles of low density to ultrafine particles of increased density corresponding to at least 90% of said intrinsic density and convert the isotropic, cubic-structure particles to tetragonal barium titanate particles, while maintaining the size of all particles below 1 micron, the particle size distribution span (dᵥ₉₀−dᵥ₁₀)/dᵥ₅₀ below 1, and the ratio of Ba:Ti including their substitutents and dopants very close to ideal stoichiometry.

The present invention thus provides a two-step process to prepare high-density tetragonal barium titanate composed of ultrafine particles in the median size range of for example 0.010 to 0.5 microns with a given aspect ratio (isotropic in shape), usually multi-facetted and preferably predominantly of cube-like shape, narrow particle size distributions, lack of agglomerates, a Ba/Ti ratio, including their substitutents and dopants, very close to the ideal stoichiometry (e.g. Ba/Ti ratio very close to 1) and high purity. This process involves the use of low cost raw materials and does not require either subsequent milling or high temperature thermal treatment, though subsequent thermal treatment is possible.

The span of particle size distribution is normally maintained at the same value or can be decreased from step (a) to step (b), with a shift of the particle size distribution (dᵥ₁₀, dᵥ₅₀, dᵥ₉₀) towards higher sizes after the solvothermal post-treatment of step (b). Thus, the particles may grow during the solvothermal post-treatment step (b), and may alter shape, however maintaining essentially the same aspect ratio (ratio of their key dimensions). In particular, the growth of isotropic particles may produce a change of shape from a generally spherical shape to a non-spherical facetted shape, for instance a cube-like shape, however conserving isotropy. The solvothermal post treatment step also produces a change of the crystal structure of the barium titanate particles from cubic to tetragonal crystal structure.

The cubic-structure particles produced in step (a) usually have a generally spherical shape, whereas the tetragonal particles produced in step (b) usually have an isotropic and facetted individual particle shape, in particular a cube-like shape. Such facetted individual particle shapes are isotropic but non-spherical and can be cube-like (six faces) or multifaceted like a hexagonal dipyramid (24 faces), but usually with no more than 30 or 48 faces.

Step (b) of the method can be followed by a heat treatment during which part or all of the particles change shape.

The tetragonal powder produced in step (b) usually has more than 50% and preferably more than 80 or 90% of facetted particles in particular of cube-like shape, however some or all of the particles may lose the facetted or cube-like shape when the particles undergo a subsequent heat treatment. The powder product, produced in step (b), or after a subsequent heat treatment, can for example have 5-95% of individual particles with an isotropic and facetted individual particle shape, in particular a cube-like shape. After various post heat treatments, the amount of the individual particles that retain an isotropic facetted shape in particular a cube-like shape can be 5-80%, 5-50% or 5-20%, for example.

This process can be applied in particular to the preparation of high density barium titanate or solid solutions of barium titanate having the general structure Ba₍₁₋ₓ₎AₓTi_{(1-y)}B_{y}O₃, where A represents one or more divalent metals such as calcium, lead, strontium, magnesium and zinc and B represents one or more tetravalent metals such as tin, zirconium and hafnium, as well as to high density doped barium titanate and high density doped solid solutions of barium titanate or other oxides based on barium and titanium having the general structure Ba₍₁₋ₓ₎AₓTi_{(1-y)}B_{y}O₃.

Firstly a low temperature (temperature usually in the range 80 or 85° C. up to boiling temperature at a pressure of 1 bar) continuous process, which may preferably implement Segmented Flow Tubular Reactor technology according to WO98/02237, is used to prepare ultrafine (e.g. spherical shaped particles of median particle size 0.005-0.5 microns) particles of low-density cubic-phase barium titanate exhibiting the above-described final characteristics except high density, the final tetragonal structure and the final usually facetted shape such as cube-like shape. In a Segmented Flow Tubular Reactor (SFTR) reaction volumes, conveniently of up to 100 ml, usually less than 20 ml, are separated by a segmenting fluid that is not miscible with the reaction mixture, in a tube typically having a diameter of about 2-10 mm. A reaction time of few minutes already is long enough to produce these low density barium titanate powders. The reaction time is the time necessary to form the barium titanate. In a tubular reactor such as an SFTR it can be convenient to maintain the reacted mixture at or about the reaction temperature for the time necessary to exit the reactor, usually a few minutes.

Alternatively, step (a) is performed using a continuous tubular reactor, a discontinuous fed-batch reactor of preferably up to 1 liter reaction volume, or using a continuous mixed suspension-mixed product removal (MSMPR) reactor of preferably up to 1 litre residence volume, taking care to rapidly heat the reaction mixture from room temperature to the reaction temperature, usually in less than 3 minutes and if necessary with stirring. Typically, a volume of up to 500 ml, in particular up to 200 ml, of the reaction mixture of step (a) is heated to the reaction temperature in a time of less than 1 minute.

Secondly, a high temperature (temperature usually above 100° C., and preferably in the range 200-350° C.) solvothermal post-treatment is applied to the e.g. spherical-shaped cubic-phase barium titanate particles produced in the first step to transform them into high-density particles exhibiting all the above-described final characteristics. For barium titanate, the transformation from the cubic-phase low density to high density and tetragonal is achieved in only 3 or 6 hours, depending on the other chemical and physical parameters, likewise for most barium titanate based solid solutions and doped compounds thereof, where however the formation of facetted shapes other than cube-like is possible.

Solvothermal treatment relates to the treatment of a solution, suspension, dispersion, emulsion or gel using a solvent at a pressure and temperature above the normal pressure and boiling point of said solvent. If water is the solvent used then such a treatment is called a hydrothermal treatment and is carried out at a pressure above 1 bar and temperature above 100° C.

This two-step process allows for the production of commercial quantities of high quality barium titanate particles including solid solutions and doped compounds thereof for specific applications, e.g. adapted for small size multilayer ceramic capacitors and embedded capacitances requiring the smallest barium titanate particles.

The invention also relates to the barium titanate powder, including solid solutions and doped compounds thereof, produced by the inventive method, in particular where the resulting particles have the defined characteristics and where at least 50%, preferably at least 80 or 90% of the individual particles have an isotropic facetted shape, in particular a cube-like shape.

Specifically, the invention includes a powder of barium titanate BaTiO₃ including solid solutions and doped compounds thereof, that is obtainable by the inventive method, which powder is composed of ultrafine particles, wherein no agglomerates are bigger than 1 μm, preferably no bigger than 0.8 μm, and having the following characteristics:
a) a primary particle size distribution determined from image analysis with a median number diameter dₙ₅₀ comprised in the range 0.005 to 0.250 μm, a maximum primary particle size of 0.5 μm, a number size distribution span (dₙ₉₀−dₙ₁₀)/dₙ₅₀ of 0.8 and below, and a geometric standard deviation σ_{g} (=dₙ₅₀/dₙ₈₄) from 0.75 to <1,
b) a particle size distribution measured by sedimentation with a median volume diameter dᵥ₅₀ comprised in the range 0.01 to 0.5 μm, without any hard agglomerate bigger than 0.8 μm, a volume size distribution span (dᵥ₉₀−dᵥ₁₀)/dᵥ₅₀ less than 0.95 and a geometric standard deviation σ_{g} (=dᵥ₅₀/dᵥ₈₄) from 0.70 to <1,
c) a factor of agglomeration (F_{AG}=dᵥ₅₀/d_{BET}) smaller than 2.1, preferably smaller than 1.6,
d) a ratio between the sedimentation dᵥ₅₀ and the image analysis dᵥ₅₀ in the range 1.0 to 1.5,
e) a tetragonal structure,
f) a density of at least 90% of the intrinsic density of a large crystal of the corresponding compound,
g) a hydroxyl content less that 1 wt %, and
h) a ratio of Ba:Ti including their substitutents and dopants equal to 1.00 plus or minus 1 atomic percent.

Further features and embodiments of the invention are set out in the claims.

### BRIEF DESCRIPTION OF THE DRAWINGS

FIG. 1 is an X-ray diffraction pattern of cubic barium titanate obtained Example 1.

FIG. 2 is the volumetric particle size distribution of the barium titanate obtained in Example 1.

FIG. 3 is an SEM micrograph of the spherical-shaped barium titanate obtained in Example 1.

FIG. 4 is the particle size distribution of the barium titanate obtained in Example 4.

FIG. 5 is an SEM micrograph of the barium titanate obtained in Example 4.

FIG. 6 is an X-ray diffraction pattern in the region 2-theta 52 to 54 degrees of tetragonal barium titanate obtained in Example 4.

FIG. 7 is an X-ray diffraction pattern in the region 2-theta 52 to 54 degrees of tetragonal barium titanate obtained in Example 8.

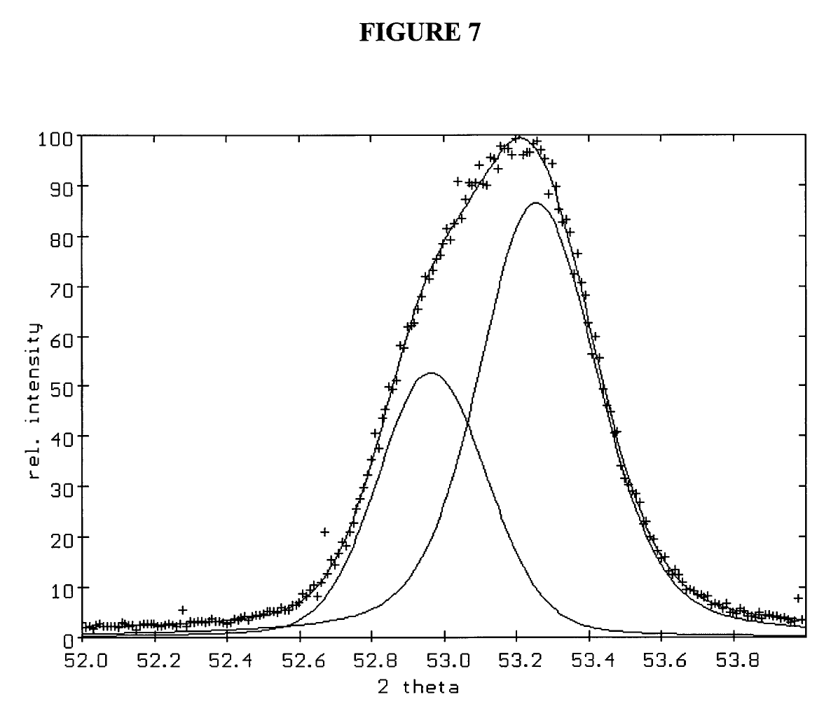

FIG. 8 is the particle size distribution of the barium titanate obtained in Example 8.

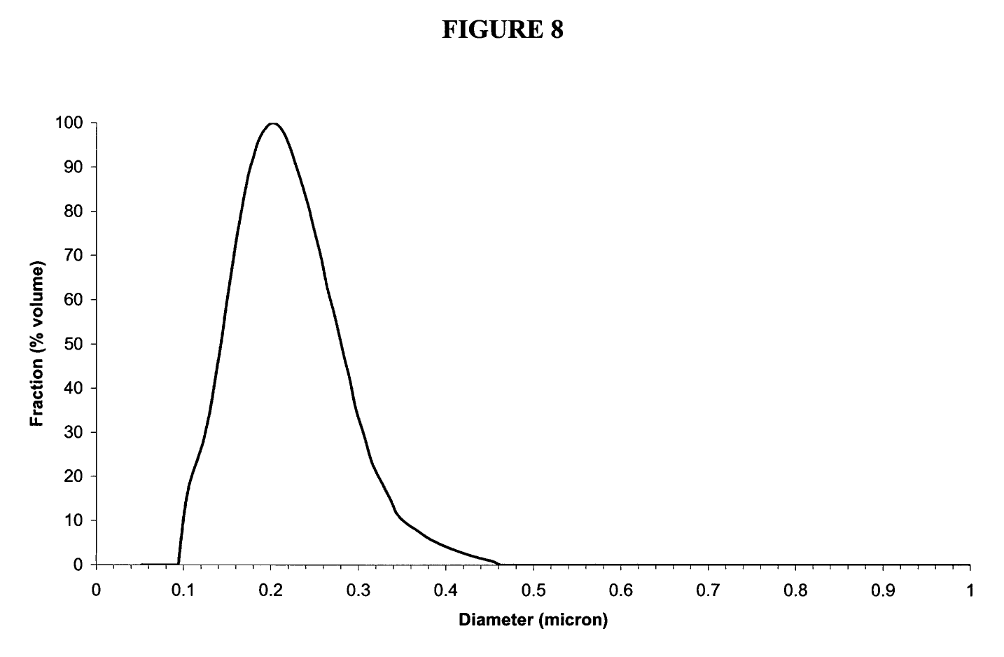

FIG. 9 is an SEM micrograph of the barium titanate obtained in Example 8.

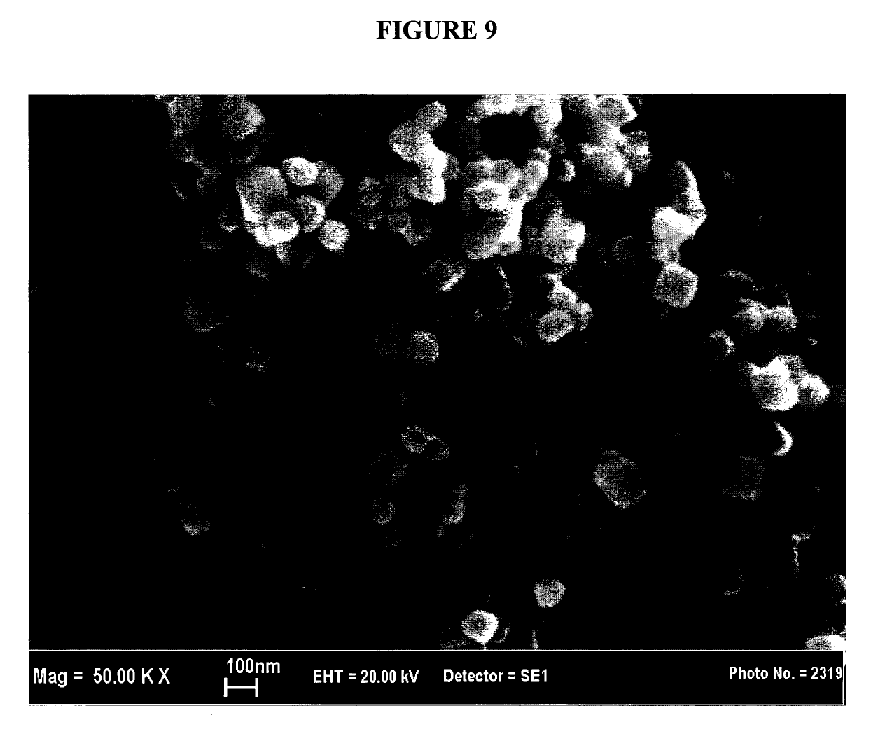

FIG. 10 is the particle size distribution of the barium titanate obtained in comparative Example 9.

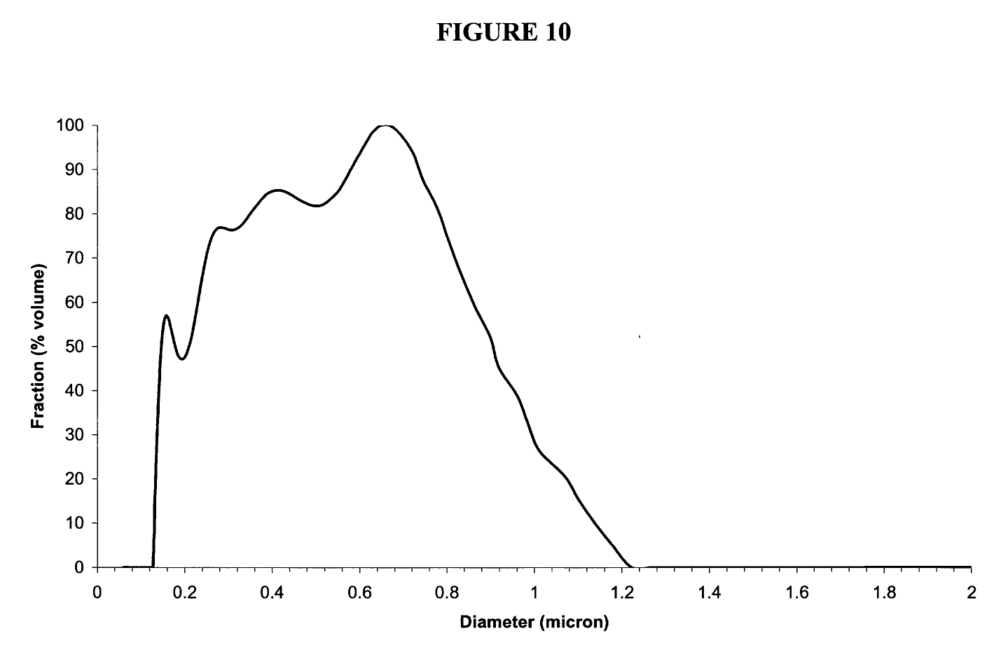

FIG. 11 is an SEM micrograph of the barium titanate obtained in comparative Example 9.

FIG. 12 is the particle size distribution of the barium titanate obtained by a comparative post heat treatment in Example 10.

### DETAILED DESCRIPTION OF THE INVENTION

Production of Basic Compounds

The present invention provides a two-step process to prepare high-density perovskite tetragonal barium titanate powders composed of ultrafine particles in the median size range 0.01 to 0.5 microns with isotropic shape, narrow particle size distributions, lack of agglomerates, a Ba/Ti ratio very close to 1 and high purity. This process involves the use of low cost raw materials and does not require either subsequent milling or high temperature thermal treatment, though subsequent thermal treatments are possible.

The first step is a low temperature continuous process where either a discontinuous one liter fed-batch reactor; or a continuous mixed suspension-mixed product removal (MSMPR) reactor of one liter residence volume; or any other process generating continuously small reaction volumes, or a continuous tubular reactor or preferably a Segmented Flow Tubular Reactor (SFTR) as described in WO98/02237, is used to prepare ultrafine low-density cubic barium titanate particles.

A first aqueous or non-aqueous solution is prepared using soluble organic or inorganic barium and titanium reactants (e.g. BaCl₂ and TiCl₄) with Ba/Ti ratio larger than 1 and titanium concentration in the range about 2.0-0.01 mol/Kg. The Ba/Ti ratio changes as a function of titanium concentration, in the range 1.01-1.2 to lead to a cubic barium titanate product of ideal stoichiometry. A second aqueous or non-aqueous solution is prepared from a strong base compound (e.g. NaOH) or another base compound such as ammonia, or tetramethylammonium hydroxide (TMAH). If the barium source is barium hydroxide, the use of a mineralizer may not be strictly required to ensure barium titanate crystallization. The two solutions are mixed, optionally using micromixers, and mechanically homogenized in order to produce a reaction mixture in the form of a liquid solution, suspension, dispersion, emulsion or a gel with a pH which is high enough, e.g. 13, preferably in the range of about 13.5-14 after complete transformation into barium titanate. Such as-prepared gel is an amorphous titanium hydroxide network with adsorbed barium ions. The reaction mixture thus prepared in the form of a liquid solution, dispersion, emulsion, suspension, or gel at room temperature is progressively fed to a SFTR and segmented with an immiscible fluid. The SFTR is maintained at the appropriate reaction temperature (in the range from 80 or 85° C. up to boiling temperature at a pressure of 1 bar), the reaction mixture being brought rapidly (in less than 30 seconds) from room temperature to the reaction temperature, for successive volumes of the reaction mixture that are less than 200 ml (the individual segmented reaction volumes can be about 20-100 ml). The reaction time is typically in the range 2 to 20 minutes. During the reaction time (“rapid ageing”), the gel or reaction mixture is transformed into single-phase low-density suspension of generally spherical-shaped barium titanate particles. The suspension is recovered and the powder washed in water until pH is above 11 and then in an NH₄OH solution until chlorine concentration in the supernatant is below 10 ppm.

X-Ray Diffraction analysis detects a typical cubic-phase barium titanate pattern without any secondary phases such as barium carbonate, Ba-rich or Ti-rich mixed oxides. The Ba/Ti ratio in the powder has been measured by Inductively Coupled Plasma spectrometry and is equal to 1.00±0.01. The density measured by helium pycnometry was usually in the range 5.0-5.1 g.cm⁻³, this value is also consistent with a cubic-phase low-density barium titanate. Thermogravimetric analysis carried out from 25 to 500° C. detects a weight loss of about 4% attributed to the removal of hydroxyls present within the barium titanate structure; this is also consistent with a cubic-phase low-density barium titanate.

Adjusting the synthesis parameters such as the reactant concentration, Ba/Ti ratio in the first solution, the temperature and the reaction mixture or gel flow rate allows for fine-tuning the median volume diameter (dᵥ₅₀) of the barium titanate particles in the range of 0.005 to 0.5 microns. The particle size distribution is measured using a sedimentation technique. The width of the volume particle size distribution is evaluated by the span, which corresponds to (dᵥ₉₀−dᵥ₁₀)/dᵥ₅₀. This span is below 1.0, typically about 0.7 (d_{vX} is a particle diameter meaning that X % of the powder volume is made of smaller sizes). At this stage, the particles have a generally spherical shape.

The second step is a high temperature solvothermal post-treatment applied to the cubic-phase low-density barium titanate particles produced in the first step to transform them into high-density tetragonal barium titanate. The temperature is above 100° C., preferably in the range 200-350° C.

During the second step, the generally spherical low-density barium titanate particles of cubic crystal structure are transformed into high-density, generally cube-shaped, tetragonal barium titanate particles, though other shapes such as non-spherical facetted shapes are possible.

Preferably, step (b) is performed by adding the barium titanate powder produced in step (a) to an aqueous solution of at least one metal compound at a pH above 9 or to a non-aqueous solution of at least one metal compound to produce a suspension, and subjecting the suspension to a solvothermal post treatment at a pressure above 1 bar and a temperature between 100° C. and 400° C., preferably in the range 200-350° C., for a residence period of 2 to 20 hours.

An aqueous or non aqueous barium solution at high pH is prepared e.g. from a barium salt or alkoxide and a strong base reactant (e.g. BaCl₂ and NaOH or NH₄OH or TMAH) or using Ba(OH)₂ Alternatively a non-aqueous solvent is used. The solution is mixed with the cubic-phase barium titanate particles prepared in the first step using the SFTR and the resulting suspension is homogenized. The solid/liquid ratio can be as large as 50% weight. The suspension is transferred to an autoclave of any suitable volume and treated at a temperature above 200° C. and for times from 2 to 20 hours (also, for comparative purposes, 1 hour). The second step can also be carried out in a continuous solvothermal apparatus. The suspension is recovered and the powder washed in water until pH is above 11 and then in an NH₄OH solution until chlorine concentration in the supernatant is below 10 ppm. After washing, the powder is dried. The pressure applied in the solvothermal is in the range above 1 to 100 bars, preferably in the range 5 to 75 bars. The heating of the solvothermal mixture can be ensured using various devices, e.g. a furnace, a bath or microwaves. Several temperature steps may be applied within the same solvothermal post-treatment. Also several solvothermal post-treatments may be applied with washing of the barium titanate powder and modification of the chemical composition of the above described aqueous or non-aqueous solution.

X-Ray Diffraction analysis detects a typical tetragonal barium titanate pattern without any secondary phases such as barium carbonate, Ba-rich or Ti-rich mixed oxides. The Ba/Ti ratio in the powder has been measured by Inductively Coupled Plasma spectrometry (ICP-AES) and is equal to 1.00±0.01. The density measured by helium pycnometry is usually in the range 5.60-5.75 g.cm⁻³ but may be increased up to 5.9 g.cm⁻³. Thermogravimetric analysis carried out from 25 to 500° C. detects a weight loss of only 0.80% maximum attributed to the removal of residual hydroxyls present within the barium titanate structure; this value slightly varies upon the post-treatment conditions.

Adjusting the synthesis parameters such as the reactant concentration, Ba/Ti ratio in the first solution, the temperature and the post-treatment time allows for fine-tuning the volume median diameter (dᵥ₅₀) of the barium titanate particles in the range of 0.01 to 0.5 microns. The particle size distribution is measured using a sedimentation technique. The width of the size distribution is evaluated by the span, which corresponds to (dᵥ₉₀−dᵥ₁₀)/dᵥ₅₀. This span is in the range 0.4-0.8, depending on the post-treatment parameters. The F_{AG}, determined from the volume median diameter (dᵥ₅₀) obtained by sedimentation and from the BET diameter d_{BET} (calculated from the specific surface area and density), is in the range 1.6 to 2.1. Determination of volume particle size distributions has also been carried out from image analysis in order to compare the ratio between the volume sizes dᵥ₁₀, dᵥ₅₀, and dᵥ₉₀ determined from sedimentation and from image analysis. Those ratios are usually in the range 1.0 to 1.6, ensuring that the powders consist of mostly soft agglomerates that can be easily dispersed. Soft agglomerates correspond to several particles held together by weak cohesive forces (van der Waals, hydrophobic or electrostatic forces) which can be broken by milling or sonication.

This solvothermal post-treatment is necessary to transform the high quality, generally spherical-shaped, cubic-phase barium titanate prepared in the first step of the process into high quality, generally cube-like or facet shaped, tetragonal barium titanate while maintaining the other key characteristics obtained through the first step (isotropic, narrow particle size distributions, lack of hard agglomerates and a Ba/Ti ratio very close to 1). Hard agglomerates are cohesive masses consisting of particulate subunits which cannot be broken by sonication or soft milling. The duration of the solvothermal post-treatment also allows for increasing the volume median particle size (dᵥ₅₀) while ensuring the particle size distribution is still narrow. In addition, after performing the solvothermal post-treatment it has been shown that the powder produced using sodium containing raw materials contains about 5 to 10 times, in some cases 10 to 20 times less sodium than before, with a sodium concentration in the range 40 to 100 ppm, in some cases 10 to 35 ppm depending on the post-treatment conditions.

Using the barium titanate powder prepared according to the method to prepare a ceramic body allows for determining dielectric properties of such a ceramic body. Cylindrical rods of 8-9.5 mm in diameter are made by isostatic pressing and sintered at different temperatures for a fixed time. Discs approximately 1 mm thick were cut from the rods, flat parallel faces were ground with emery and gold electrodes were evaporated onto them in order to prepare a capacitor. The capacitance and dielectric losses were measured between 30 and 170° C. and were satisfactory for commercial applications

Optional Heat Treatments

The high quality cube-like tetragonal barium titanate powder may further be heat treated in a continuous or discontinuous furnace at a temperature typically within the range from 400 to 1200° C. for durations usually from a few minutes up to 48 hours where the heating rate, the type of gas or gas mixtures used as well as their partial pressure may be adjusted. This heat treatment may lead to bigger particles or not. Conditions are selected so that high quality tetragonal barium titanate powder with narrow particle size distribution (span <1.0), without agglomerates above 0.8 micron is obtained. Conditions can be selected so that the F_{AG} remains in the same range as before the heat treatment (usually below 2.0) as well as the ratios of the volume sizes obtained by sedimentation and image analysis (below 2.0). Median size may increase as a function of temperature and duration of the heat treatment. Thermogravimetric analysis shows a weight loss attributed to the presence of hydroxyls in the barium titanate structure below 0.7% after such heat treatments. During this optional heat treatment the particles maintain isotropy but lose partially the distinctive multifaceted or cube-like form above 900 to 1200° C., also depending on the other parameters (e.g. time, heating rate, atmosphere). Subsequent milling treatment is possible.

Substitution and Doping

The electrical properties of barium titanate can be substantially modified by the incorporation of barium and titanium substituants to form solid solutions and/or as dopants.

Solid solutions of barium titanate have the general structure Ba₍₁₋ₓ₎AₓTi_{(1-y)}B_{y}O₃, where A represents one or more divalent metals such as calcium, cadmium, europium, magnesium, lead, radium, strontium and zinc and B represents one or more tetravalent metals such as cerium, cobalt, iron, hafnium, molybdenum, lead, praseodymium, plutonium, ruthenium, tin, thorium, titanium, uranium, vanadium and zirconium.

One type of barium titanate-based composition has the structure Ba₍₁₋ₓ₎AₓTi_{(1-y)}B_{y}O₃, where the mole fractions x and y can be in the range of 0 to 1, preferably larger than 0.03, where A represents one or more divalent metal other than barium such as calcium, cadmium, europium, magnesium, lead, radium, strontium and zinc and B represents one or more tetravalent metals other than titanium such as cerium, cobalt, iron, hafnium, molybdenum, lead, praseodymium, plutonium, ruthenium, tin, thorium, uranium, vanadium and zirconium.

Where the divalent or tetravalent metals are present as dopants, the value of the mole fraction x and y may be small, for example less than 0.1.

In other cases, the divalent or tetravalent metals may be introduced at higher levels to provide a significantly identifiable compound such as barium-calcium titanate, barium-strontium titanate, barium titanate-zirconate and the like.

The powder composition also shows a mole ratio of (Ba+A)/(Ti+B) close to 1.00.

Different cations (e.g. calcium, cadmium, europium, magnesium, lead, radium, zinc, cerium, iron, hafnium, molybdenum, praseodymium, plutonium, ruthenium, tin, thorium, uranium and zirconium e.g. in the form of chlorides but not limited to chlorides), one or more as desired, can substitute the barium (or A) and/or titanium (or B) reactants of the first solution used to prepare the reaction mixture in the form of a liquid, suspension, emulsion or gel before completing the first step of the process. The low density barium titanate-based particles prepared though the first step of the process are then transformed into high density barium titanate-based particles Ba₍₁₋ₓ₎AₓTi_{(1-y)}B_{y}O₃ through the above-described solvothermal post-treatment.

Dopants cover a wide range of metal oxides. These, in general but not limited, represent less than 0.05 mole fraction of the total Ba₍₁₋ₓ₎AₓTi_{(1-y)}B_{y}O₃ formulation. The dopant or dopants employed may be completely or partially miscible in the perovskite lattice or may be immiscible in the lattice. The dopant is selected from the group consisting of elements such as lanthanum, rare earth elements, lithium, magnesium, yttrium, niobium, tantalum, gallium, molybdenum, tungsten, manganese, copper, iron, cobalt, nickel, chromium, zinc, aluminium, silicon, antimony, lead, bismuth, boron and mixtures thereof and is different to A and B.

It is possible to obtain homogeneously doped low density barium titanate or doped low density Ba₍₁₋ₓ₎AₓTi_{(1-y)}B_{y}O₃ compound using a modified procedure of the first step of the process. The desired cations are added in the form of organic or inorganic compounds (e.g. chlorides) to the first aqueous or non-aqueous solution containing soluble barium and titanium reactants either before or after the reaction mixture in the form of liquid, suspension, emulsion or gel is prepared, and then reacted in the SFTR or another type of reactor as described for the manufacture of pure barium titanate. The doped barium titanate or low density doped Ba₍₁₋ₓ₎AₓTi_{(1-y)}B_{y}O₃ compound prepared though the first step of the process is then transformed into high density doped barium titanate or high density doped Ba₍₁₋ₓ₎AₓTi_{(1-y)}B_{y}O₃ compound through the above-described solvothermal post-treatment.

Another route to prepare heterogeneously doped barium titanate with a concentration gradient decreasing from the particles surface to their core is to use pure low density barium titanate prepared through the first step of the process and modify the second step of the process by replacing (or adding to) the barium compound in the barium solution the desired metallic cation(s) to obtain doped high density barium titanate. Adjusting the dopant concentration in the slightly acidic or alkaline solution (depending on the nature of the dopant element) allows for either getting a gradient or a homogenous distribution of dopant within the particles.

This last route can also be used to prepare doped Ba₍₁₋ₓ₎AₓTi_{(1-y)}B_{y}O₃ compound with a concentration gradient decreasing from the particles surface to their core. This route uses low density Ba₍₁₋ₓ₎AₓTi_{(1-y)}B_{y}O₃ compound prepared through the first step of the process and the second step of the process is modified by replacing the barium and/or the A compound in the slightly acidic or alkaline solution by the desired metallic cation(s) in order to produce high density doped Ba₍₁₋ₓ₎AₓTi_{(1-y)}B_{y}O₃. Adjusting the dopant concentration in the slightly acidic or alkaline solution allows for either producing a gradient or a homogenous distribution of dopant within the particles.

Several solvothermal post-treatments may be carried out one after the other, each one allowing doping with a single or several dopants. Also, a solvothermal post-treatment may be carried out without the presence of a dopant but only with appropriate solvent or solvent mixture. For substituted and doped barium titanate, the particles may adopt other facetted shapes than cube-like after the solvothermal treatment, the facetted shape depending on the substitutents/dopants and the process conditions.

### EXAMPLES

The present invention will be described in more detail hereinunder by Examples, but the Examples are only illustrative and, therefore, not intended to limit the scope of the present invention thereto.

Various properties were measured by the following methods.
(a) The shape of the barium titanate particles was determined from micrographs made during scanning electron microscope (SEM, PHILIPS model XL-30 FEG or 515) observations. The aspect ratio of a particle can also be determined from micrographs. The aspect ratio corresponds to the ratio between the longest dimension and the shortest dimension of the particle, i.e. the aspect ratio of a rod is bigger than 1, the aspect ratio of a disc or platelet is smaller than 1 while it equals 1 for a sphere. More generally, the aspect ratio is defined as the ratio between the particle axis h and the axis b. In a Cartesian coordinate system, h corresponds to the z direction and b to the x-y direction for symmetric bodies. Oblate spheroids will then have aspect ratios h/b<1 and prolate spheroids will have axial ratios h/b>1.
(b) The number primary particle size distributions of the barium titanate particles were measured by image analysis from scanning electron micrograph in order to determine the edges of the cube-shaped primary particles. Two or more touching particles were visually disaggregated and the sizes of the individual primary particles were measured. The edges were used to compute the cumulative number percent distribution as a function of primary particle size. The number particle size distribution is characterized by dₙ₁₀, dₙ₂₅, dₙ₅₀, dₙ₇₅, dₙ₈₄, dₙ₉₀: d_{nX} is a particle diameter meaning that X % of the number of particles is made of smaller sizes e.g. 10% of the particles is composed of smaller particle sizes for dₙ₁₀. Also dₙ₁₀₀ corresponds to the biggest particle edge of the number particle size distribution. The width of the number distribution is defined by the span ([dₙ₉₀−dₙ₁₀]/dₙ₅₀). The smaller the span, the narrower is the particle size distribution. The geometric standard deviation π_{g} is calculated from the following ratio dₙ₅₀/dₙ₈₄, it provides another indication of the width of the number size distribution. The closer to 1, the narrower the size distribution is. The quartile ratio, QR, defined as the upper quartile diameter (dₙ₇₅) divided by the lower quartile diameter (dₙ₂₅), is another measure of the width of the distribution: the size distribution is extremely narrow when QR is close to 1, the bigger QR is, the wider is the size distribution.
   The equivalent spherical diameters of the cube-shaped particles were used to compute the cumulative volume percent distribution as a function of primary particle size. The volume particle size distribution is characterized by dᵥ₁₀, dᵥ₂₅, dᵥ₅₀, dᵥ₇₅, dᵥ₈₄, dᵥ₉₀ (d_{vX} is a particle diameter meaning that X % of the powder volume is made of smaller sizes). The width of the volume distribution is defined by the span ([dᵥ₉₀−dᵥ₁₀]/dᵥ₅₀). The smaller the span, the narrower is the particle size distribution. The geometric standard deviation σ_{g} is calculated from the following ratio dᵥ₉₀/dᵥ₈₄, it provides another indication of the width of the volume size distribution; the closer to 1, the narrower the size distribution is. The quartile ratio, QR, defined as the upper quartile diameter (dᵥ₇₅) divided by the lower quartile diameter (dᵥ₂₅), is another measure of the width of the distribution: the size distribution is extremely narrow when QR is close to 1, the bigger QR is, the wider is the size distribution.
(c) The volumetric particle size distributions of the barium titanate particles were measured by sedimentation (XDC, BI-XDCP Particle Sizer, Brookhaven Instrument Corporation). The sedimentation process reports particle size distribution of the powder in terms of the equivalent spherical diameter. This measure represents the diameter of a sphere that would settle at the same terminal velocity as the particle in question. This method is very representative of the system analyzed if the particles are approximately equi-axed. Also, the particles measured using sedimentation correspond to secondary particles made of several primary particles bound together but acting as single entities. To prepare a suspension for particle size distribution measurement, 0.5 g of dry powder was dispersed in 40 ml of a 0.1 wt % polyacrylic acid solution. The suspension was sonicated with an ultrasound horn for 15 minutes. The measurement was carried out at 25° C. with a disk speed of 1500 rpm (higher disc speeds are used for smaller particles). The particle size distribution is characterized by dᵥ₁₀, dᵥ₅₀, dᵥ₈₄, dᵥ₉₀: dᵥ₁₀ means that 10% of the powder volume is composed of smaller particle sizes, dᵥ₅₀ means that 50% of the powder volume is composed of smaller particle sizes, dᵥ₈₄ means that 84% of the powder volume is composed of smaller particle sizes and dᵥ₉₀ means that 90% of the powder volume is made of smaller sizes. Also dᵥ₁₀₀ corresponds to the biggest equivalent diameter of the volume particle size distribution. The width of the volume distribution obtained by sedimentation is defined by the span ([dᵥ₉₀−dᵥ₁₀]/dᵥ₅₀). The smaller the span, the narrower is the particle size distribution. The geometric standard deviation σ_{g} is calculated from the ratio dᵥ₅₀/dᵥ₈₄, it provides another indication of the width of the volume size distribution. The closer to 1, the narrower the size distribution is. The percentage of agglomerates bigger than 1 micron was also calculated from the particle size distribution data.
(d) Since particle sizes determined by image analysis and by sedimentation depend on different principles, an exact correspondence in size by these two methods is rarely obtained. Moreover in image analysis touching primary particles are visually disaggregated. In the sedimentation process bound or flocculated particles act as single entities. These entities usually named secondary particles arise because of the existence of some bonding (e.g., necking) between the primary particles giving hard agglomerates which cannot be readily broken down during the sonication process. The ratios between the dᵥ₁₀ dᵥ₅₀ and dᵥ₉₀ values determined by sedimentation and those respectively found from image analysis were calculated: the smaller they are, the less primary particles compose a secondary particle determined by sedimentation. As expected, they were usually larger than 1 but smaller than 2.
(e) The specific surface area value was measured by the BET method using a Gemini Micromeritics apparatus after the powder had been heated for 1 hour at 220° C.
(f) The densities were measured using helium pycnometry (Micromeritics AccuPyc1330) pycnometry after the powder was heated for minimum 24 h at 110° C. to make sure all adsorbed water had been eliminated.
(g) The BET diameter d_{BET} is calculated from the BET specific surface area and the density of the powder measured by pycnometry using the following equation d_{BET}=6/(density×BET specific surface area), assuming particles are spherical or cube-shaped and the primary particle size distribution is narrow. Dispersibility of the powders was assessed by comparing the d_{BET} and median size dᵥ₅₀ determined by sedimentation procedure. The agglomeration factor (F_{AG}=dᵥ₅₀/d_{BET}) indicates the state of agglomeration of the powder under investigation.
(h) The Ba/Ti ratio was measured using inductively coupled plasma spectrometry (ICP-AES, Perkin Elmer, Plasma 2000 software) as well as the sodium concentration in the powder.
(i) Phase purity was investigated by X-ray diffraction (XRD, Co K_{α} radiation, model PW1710, Philips, Eindhoven, The Netherlands) on as-prepared powders and after calcination for 6 h at 950° C. and 1350° C. Phase composition after annealing is very sensitive to the overall Ba/Ti molar ratio of the solid. Formation of secondary phases is already observed by XRD for deviations of ±1 at. % from the ideal stoichiometry if the diffraction pattern is carefully collected. As to the tetragonality of the barium titanate particles of the present invention, the value of c/a has been calculated, wherein ‘a’ and ‘c’ are lattice constants for the respective ‘a’ and ‘c’ crystal axes.
(j) Thermogravimetric analysis (Mettler TG50 thermobalance) measured in the range 200 to 500° C. allowed for determining the amount of hydroxyls contained in the barium titanate structure before and after the solvothermal post-treatment. The measurements were carried out after the powder was heated for minimum 24 h at 110° C. to make sure all adsorbed water had been eliminated.

### Production of Powder from First Step of the Process

### Example 1a

To prepare 1 kg of cubic-phase barium titanate with a volume median size (dᵥ₅₀) of 75 nm detemined by sedimentation, twelve litres of gel were prepared at ambient temperature by mixing 6 litres of a NaOH solution at a concentration of 4.42 mol/kg and 6 litres of BaCl₂ and TiCl₄ solution at a concentration of 0.561 mol/kg and 0.550 mol/kg respectively. The gel was fed to a Segmented Flow Tubular Reactor comprising a tube immersed in a water bath maintained at 98° C. A heating time from room temperature to 98° C. within less than 20 seconds was ensured. The residence time of the gel in the tube was between 3 to 5 minutes, over the 2 minutes reaction time required to transform the gel into a suspension of barium titanate nanoparticles at this temperature. The suspension was collected at the outlet of the tube in a vessel maintained at room temperature. The suspension was then allowed to decant for 2 hours and about 10 litres of supernatant were removed from the storage vessel. The powder washed in several steps and then dried. The powder was then characterized.

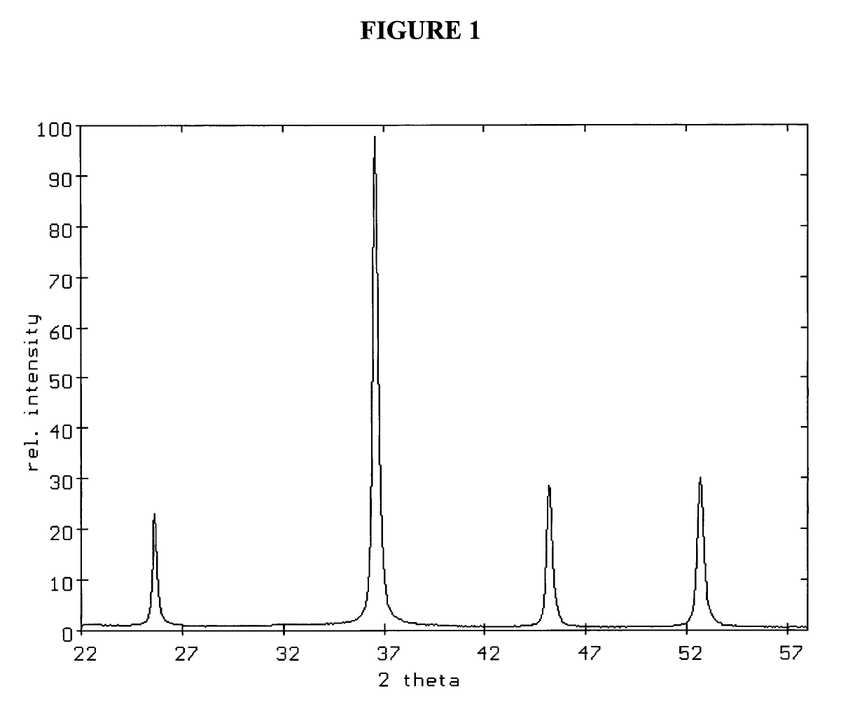

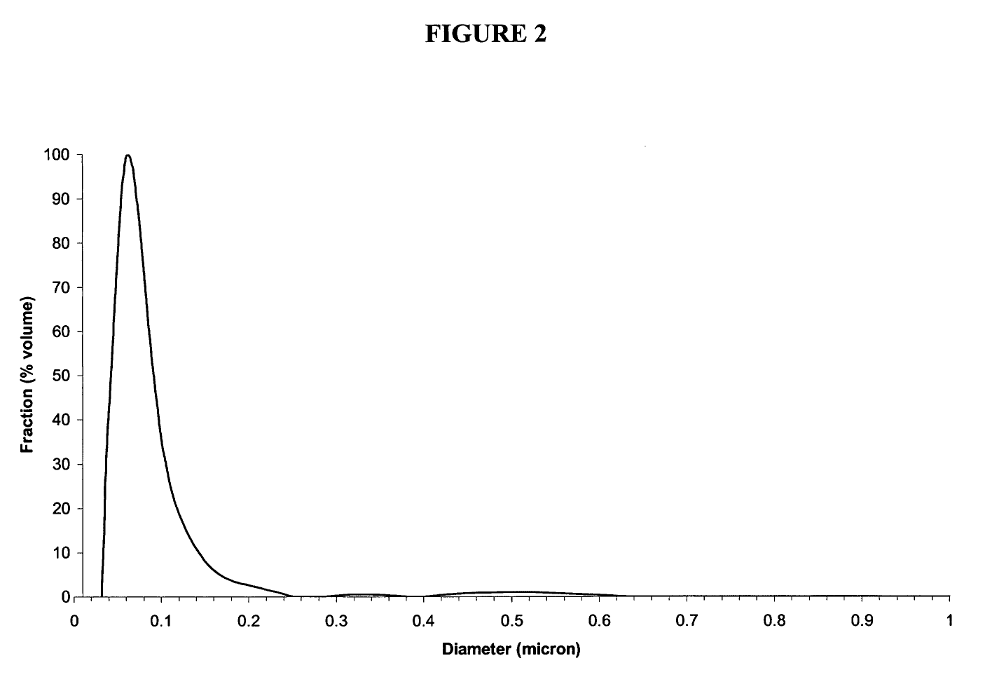

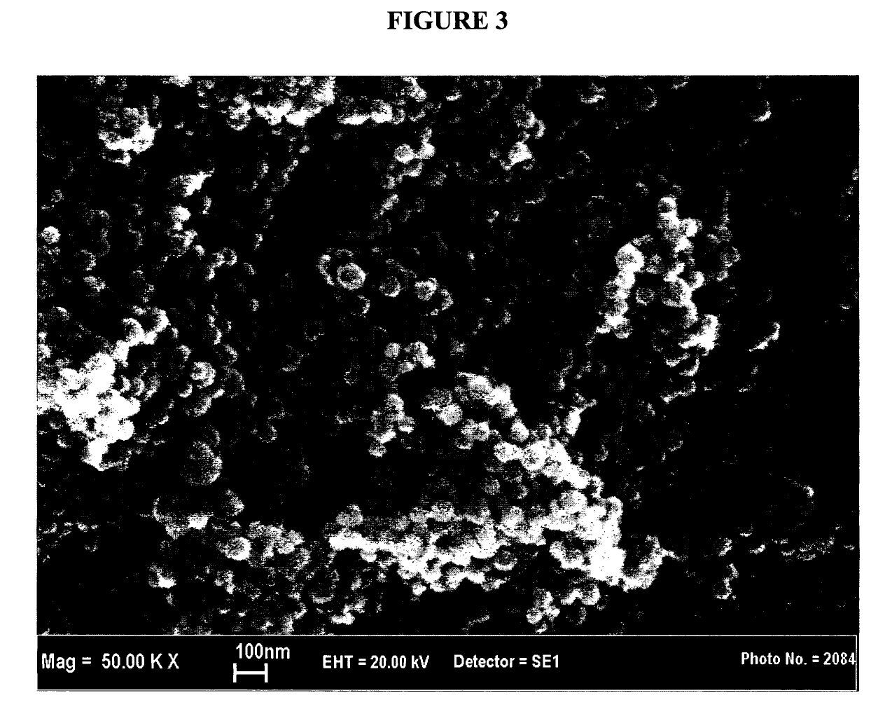

As presented in Table 1 and illustrated by FIG. 2, the volume particle size distribution determined by sedimentation shows dᵥ₅₀ of 75 nm with a dᵥ₁₀ and dᵥ₉₀ of 48 nm and 116 nm respectively. FIG. 1 shows the X-ray diffraction pattern of the resulting cubic-phase barium titanate, also since no diffraction peaks attributed to substances other than BaTiO₃ were recognized, it was confirmed that the obtained particles consisted of BaTiO₃. The powder is considered as cubic-phase as no peak splitting has been identified and c/a=1.000 (see Table 3). Also FIG. 3 shows a SEM micrograph of the spherical-shaped barium titanate particles prepared. The density of this powder is 5.00 g.cm⁻³. The Ba/Ti equals 1.00. The powder also contains 500 ppm of sodium inherent to NaOH used in this synthesis route. Finally, thermogravimetric analysis shows a weight loss of 4.2% in the range 200 to 500° C. attributed to the presence of hydroxyls in the barium titanate structure.

### Example 1b

To prepare 1 kg of cubic-phase barium titanate with a volume median size (dᵥ₅₀) of 155 nm detemined by sedimentation, in a variation of Example 1a, twelve litres of gel were prepared at ambient temperature by mixing 6 litres of a NaOH solution at a concentration of 1.6 mol/kg and 6 litres of BaCl₂ and TiCl₄ solution at a concentration of 0.22 mol/kg and 0.20 mol/kg respectively. The gel was fed to a Segmented Flow Tubular Reactor comprising a tube immersed in a water bath maintained at 87° C. A heating time from room temperature to 87° C. within less than 20 seconds was ensured. The residence time of the gel in the tube was between 8 to 10 minutes, over the time (about 3-4 minutes) required to transform the gel into a suspension of barium titanate nanoparticles at this temperature. The suspension was collected at the outlet of the tube in a vessel maintained at room temperature. The suspension was then allowed to decant for 2 hours and about 10 litres of supernatant were removed from the storage vessel. The powder washed in several steps and then dried. The powder was then characterized.

The volume particle size distribution determined by sedimentation shows dᵥ₅₀ of 155 nm with a dᵥ₁₀ and dᵥ₉₀ of 101 nm and 252 nm respectively. X-ray diffraction pattern shows cubic barium titanate and no diffraction peaks attributed to substances other than BaTiO₃ were recognized. The powder is considered as cubic-phase as no peak splitting has been identified and c/a=1.000 (see Table 3). SEM micrograph observations showed spherical-shaped barium titanate particles. The density of this powder is 5.00 g.cm⁻³. The Ba/Ti ratio equals 1.00.

The resulting particles can then be subjected to hydrothermal post treatment according to the invention, for instance as described in Examples 2 to 8 for Example 1a's particles.

### Second Step of the Process

### Example 2—Hydrothermal Post-Treatment

The hydrothermal post-treatment was carried out by mixing 2 g of barium titanate produced according to procedure described in Example 1a with 30 g of a Ba(OH)₂ solution. This solution was initially prepared by dissolving 16.7 g of Ba(OH)₂ in 1 litre of water. The suspension was placed in a 40 ml hydrothermal autoclave, itself placed in an oven heated at 250° C. Reaching a temperature of 250° C. inside the autoclave required 1 hour, the autoclave was then allowed to stay at this temperature for 1 hour and then to cool naturally to room temperature. The suspension was recovered and the supernatant was removed. The powder washed in several steps and then dried. The powder was then characterized.

As presented in Table 1, the volume particle size distribution determined by sedimentation shows dᵥ₅₀ of 106 nm with a dᵥ₁₀ and dᵥ₉₀ of 71 nm and 15 μm respectively without any agglomerate above 250 nm. Image analysis has been carried out in order to define number and volume particle size distributions (see Tables 4 and 5). Table 6 shows that the ratio of dᵥ₁₀, dᵥ₅₀ and dᵥ₉₀ determined by sedimentation and image analysis is about 1. The particle shape is no longer spherical but predominantly cube-like (85%). The powder is of tetragonal crystal structure as an X-Ray diffraction peak splitting has been identified and c/a=1.002 (see Table 3). The density of this powder has increased compared to the Example 1a powder: it is 5.60 (±0.09) g.cm⁻³. The powder only contains 34 ppm of sodium compared to 500 ppm of Example 1a. Finally, thermogravimetric analysis shows a weight loss of 0.80% in the range 200 to 500° C. attributed to the presence of residual hydroxyls in the barium titanate structure.

Scaling up of Examples 2 to 8 to a 2-litre autoclave gives the same results.

### Example 3—Hydrothermal Post-Treatment

The hydrothermal post-treatment was carried out using the same procedure as Example 2, except the hydrothermal autoclave was maintained at 250° C. for 2 hours instead of 1 hour.

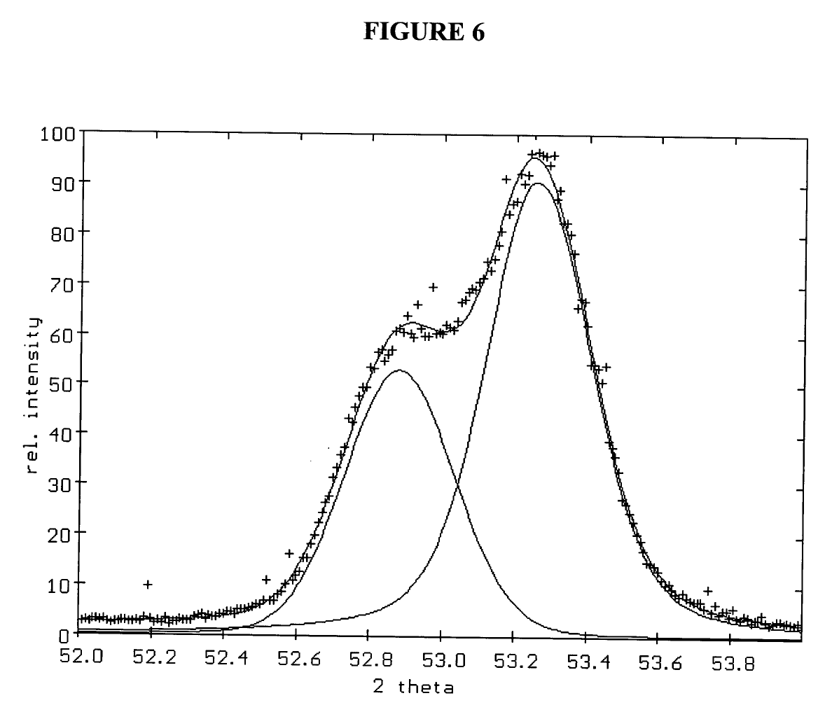

As presented in Table 1, the volume particle size distribution determined by sedimentation shows dᵥ₅₀ of 130 nm with a dᵥ₁₀ and dᵥ₉₀ of 85 nm and 189 nm respectively without any agglomerate above 365 nm. Image analysis has been carried out in order to define number and volume particle size distributions (see Tables 4 and 5). Table 6 shows that the ratio of dᵥ₁₀, dᵥ₅₀ and dᵥ₉₀ determined by sedimentation and image analysis is about 1. As shown in FIG. 6, the powder is of tetragonal crystal structure as a peak splitting has been identified and c/a=1.006 (see Table 3). Also according to SEM observations of the barium titanate particles, their shape has now become more cube-like than spherical: more than 85% of the particles have an individual cube-like shape. The density of this powder is 5.58 (±0.10) g.cm⁻³. The powder also only contains 26 ppm of sodium compared to 500 ppm of Example 1a. Finally, thermogravimetric analysis shows a weight loss of 0.70% in the range 200 to 500° C. attributed to the presence of residual hydroxyls in the barium titanate structure.

### Example 4—Hydrothermal Post-Treatment

The hydrothermal post-treatment was carried out using the same procedure as Example 2, except the hydrothermal autoclave was maintained at 250° C. for 6 hours instead of 1 hour.

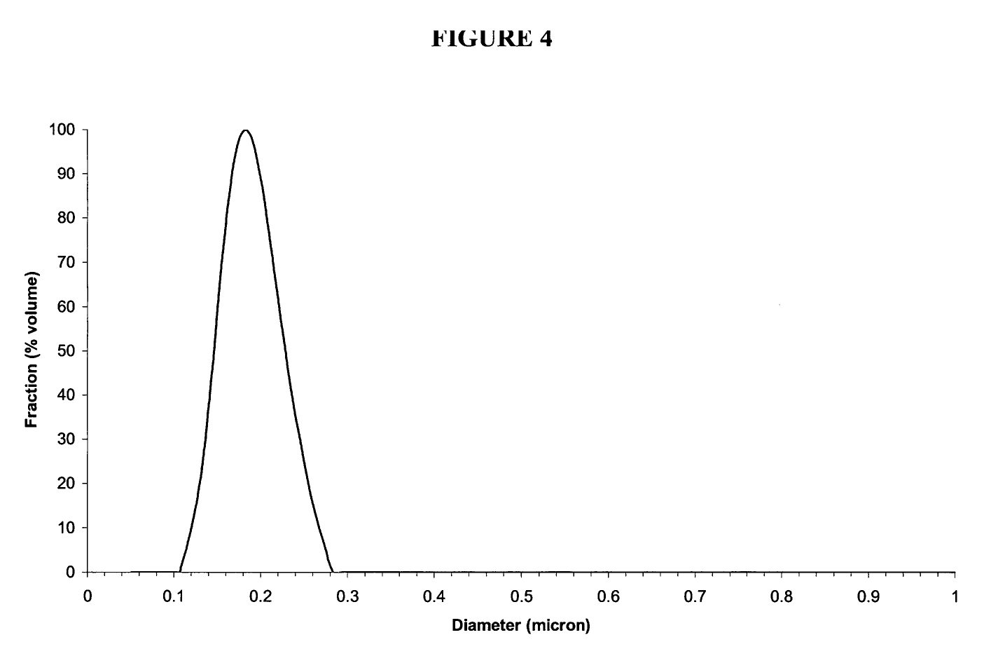

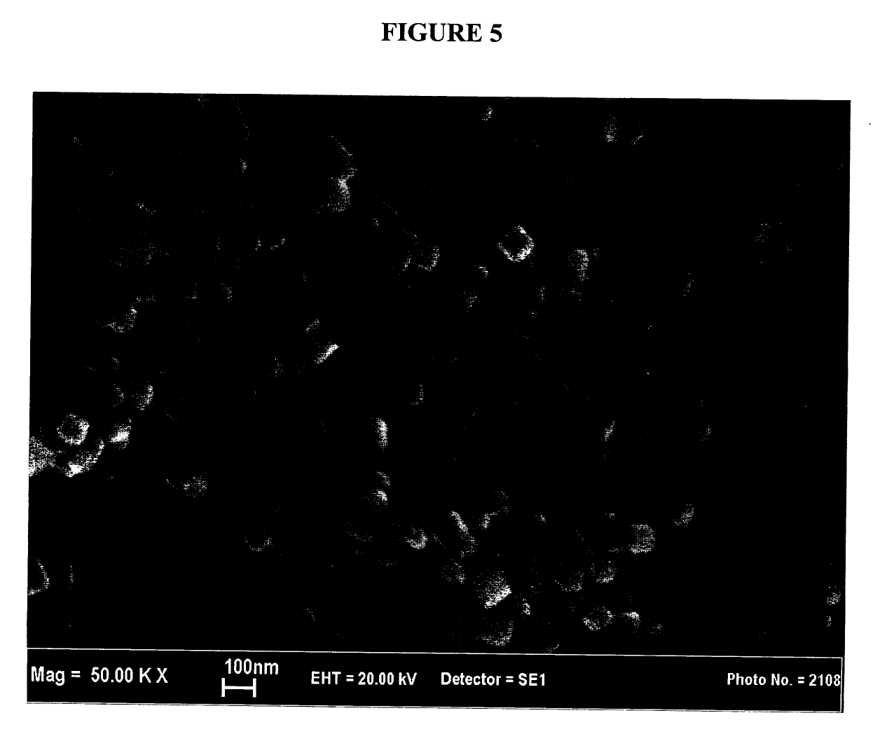

As presented in Table 1 and illustrated by FIG. 4, the volume particle size distribution determined by sedimentation shows dᵥ₅₀ of 187 nm with a dᵥ₁₀ and dᵥ₉₀ of 152 nm and 229 nm respectively without any agglomerate above 265 nm. Image analysis has been carried out in order to define number and volume particle size distributions (see Tables 4 and 5). Table 6 shows that the ratio of dᵥ₁₀, dᵥ₅₀ and dᵥ₉₀ determined by sedimentation and image analysis is about 1.5. FIG. 5 shows a SEM micrograph of the particles where 90% of individual particles present a cube-like shape. The powder is of tetragonal crystal structure as an X-Ray diffraction peak splitting has been identified and c/a=1.007 (see Table 3). The density of this powder has increased compared to the Example 1a powder: it is 5.73 (±0.06) g.cm⁻³ and its specific surface area is 11.6 m²/g (see Table 2). The Ba/Ti equals 1.00. The powder only contains 31 ppm of sodium compared to 500 ppm of Example 1a. Finally, thermogravimetric analysis shows a weight loss of 0.70% in the range 200 to 500° C. attributed to the presence of residual hydroxyls in the barium titanate structure.

### Example 5—Hydrothermal Post-Treatment

The hydrothermal post-treatment was carried out by mixing 2 g of barium titanate produced according to procedure described in Example 1a with 30 g of a BaCl₂ and NaOH solution. This solution was initially prepared by dissolving 13.66 g of BaCl₂ and 5 g of NaOH in 1 litre of water. The suspension was placed in a 40 ml hydrothermal autoclave, itself placed in an oven heated at 250° C. Reaching a temperature of 250° C. inside the autoclave required 1 hour, the autoclave was then allowed to stay at this temperature for 6 hours and then to cool naturally to room temperature. The suspension was recovered and the supernatant was removed. The powder washed in several steps and then dried. The powder was then characterized.

As presented in Table 1, the volume particle size distribution determined by sedimentation shows dᵥ₅₀ of 154 nm with a dᵥ₁₀ and dᵥ₉₀ of 105 nm and 217 nm respectively without any agglomerate above 350 nm. Image analysis has been carried out in order to define number and volume particle size distributions (see Tables 4 and 5). Table 6 shows that the ratio of dᵥ₁₀, dᵥ₅₀ and dᵥ₉₀ determined by sedimentation and image analysis is in the range 1.1 to 1.6. According to SEM observations 86% of individual particles present a cube-like shape. The powder is of tetragonal crystal structure as an X-Ray diffraction peak splitting has been identified and c/a=1.006 (see Table 3). The density of this powder has increased compared to the Example 1a powder: it is 5.71 (+0.01) g.cm⁻³ and its specific surface area is 12.1 m²/g (see Table 2). The Ba/Ti equals 1.00. The powder only contains 65 ppm of sodium compared to 500 ppm of Example 1a. Finally, thermogravimetric analysis shows a weight loss of 0.80% in the range 200 to 500° C. attributed to the presence of residual hydroxyls in the barium titanate structure.

### Example 6—Hydrothermal Post-Treatment

The hydrothermal post-treatment was carried out by mixing 2 g of barium titanate produced according to procedure described in Example 1a with 30 g of a BaCl₂ and NaOH solution at pH 14. This solution was initially prepared by dissolving 13.66 g of BaCl₂ and 40 g of NaOH in 1 litre of water. The suspension was placed in a 40 ml hydrothermal autoclave, itself placed in an oven heated at 250° C. Reaching a temperature of 250° C. inside the autoclave required 1 hour, the autoclave was then allowed to stay at this temperature for 6 hours and then to cool naturally to room temperature. The suspension was recovered and the supernatant is removed. The powder washed in several steps and then dried. The powder was then characterized.

As presented in Table 1, the volume particle size distribution determined by sedimentation shows dᵥ₅₀ of 176 nm with a dᵥ₁₀ and dᵥ₉₀ of 113 nm and 248 nm respectively without any agglomerate above 380 nm. Image analysis has been carried out in order to define number and volume particle size distributions (see Tables 4 and 5). Table 6 shows that the ratio of dᵥ₁₀, dᵥ₅₀ and dᵥ₉₀ determined by sedimentation and image analysis is in the range 1.1 to 1.6. According to SEM observations 96% of individual particles present a cube-like shape. The powder is of tetragonal crystal structure as an X-Ray diffraction peak splitting has been identified and c/a=1.006 (see Table 3). The density of this powder has increased compared to the Example 1a powder: it is 5.67 (±0.05) g.cm⁻³ and its specific surface area is 10.5 m²/g (see Table 2). The Ba/Ti ratio equals 1.00. The powder only contains 106 ppm of sodium compared to 500 ppm of Example 1a. Finally, thermogravimetric analysis shows a weight loss of 0.72% in the range 200 to 500° C. attributed to the presence of residual hydroxyls in the barium titanate structure.

### Example 7—Hydrothermal Post-Treatment

The hydrothermal post-treatment was carried out by mixing 2 g of barium titanate produced according to procedure described in Example 1a with 30 g of a BaCl₂ and NaOH solution at pH=14. This solution was initially prepared by dissolving 13.6 g of BaCl₂ and 66 g of NaOH in 1 litre of water. The suspension was placed in a 40 ml hydrothermal autoclave, itself placed in an oven heated at 250° C. Reaching a temperature of 250° C. inside the autoclave required 1 hour, the autoclave was then allowed to stay at this temperature for 2 hours and then to cool naturally to room temperature. The suspension was recovered and the supernatant was removed. The powder washed in several steps and then dried. The powder was then characterized.

As presented in Table 1, the volume particle size distribution determined by sedimentation shows dᵥ₅₀ of 155 nm with a dᵥ₁₀ and dᵥ₉₀ of 117 nm and 205 nm respectively. Image analysis has been carried out in order to define number and volume particle size distributions (see Tables 4 and 5). Table 6 shows that the ratio of dᵥ₁₀, dᵥ₅₀ and dᵥ₉₀ determined by sedimentation and image analysis is in the range 1.1 to 1.3. According to SEM observations 91% of individual particles present a cube-like shape. The powder is of tetragonal crystal structure as an X-Ray diffraction peak splitting has been identified and c/a=1.002 (see Table 3). The density of this powder has increased compared to the Example 1a powder: it is already 5.65 (+0.01) g.cm⁻³ after only 2 hours of post-treatment at 250° C. and its specific surface area is 11.3 m²/g (see Table 2). The Ba/Ti ratio equals 1.00. The powder only contains 228 ppm of sodium compared to 500 ppm of Example 1a. Finally, thermogravimetric analysis shows a weight loss of 1.00% attributed in the range 200 to 500° C. to the presence of residual hydroxyls in the barium titanate structure.

### Example 8—Hydrothermal Post-Treatment

The hydrothermal post-treatment was carried out using the same procedure as Example 7 except the hydrothermal autoclave was maintained at 250° C. for 6 hours instead of 2 hours. The suspension was recovered and the supernatant was removed. The powder washed with several liquids and then dried. The powder was then characterized.

As presented in Table 1, the volume particle size distribution determined by sedimentation shows dᵥ₅₀ of 214 nm with a dᵥ₁₀ and dᵥ₉₀ of 147 nm and 297 nm respectively. Image analysis has been carried out in order to define number and volume particle size distributions (see Tables 4 and 5). Table 6 shows that the ratio of dᵥ₁₀ g dᵥ₅₀ and dᵥ₉₀ determined by sedimentation and image analysis is in the range 1.1 to 1.3. According to SEM observations 87% of individual particles present a cube-like shape. The powder is of tetragonal crystal structure as an X-Ray diffraction peak splitting has been identified and c/a=1.005 (see Table 3). The density of this powder has increased compared to the Example 1a powder, it is 5.668 (±0.005) g.cm⁻³ and its specific surface area is 10.2 m²/g (see Table 2). The Ba/Ti equals 1.00. The powder only contains 104 ppm of sodium compared to 500 ppm of Example 1a. Finally, thermogravimetric analysis shows a weight loss of 0.67% in the range 200 to 500° C. attributed to the presence of residual hydroxyls in the barium titanate structure.

### Comparative Examples 9 and 10

### Comparative Example 9—Production of Powder in One Step

Instead of being fed to the SFTR, 150 ml of gel prepared according to the procedure of Example 1a was placed in a 250 ml hydrothermal autoclave, itself placed in an oven heated at 250° C. Reaching a temperature of 250° C. inside the autoclave required 1 hour, the autoclave was then allowed to stay at this temperature for 19 hours and then to cool naturally to room temperature. The suspension was recovered and the supernatant was removed. The powder washed in several steps and then dried. The powder was then characterized.

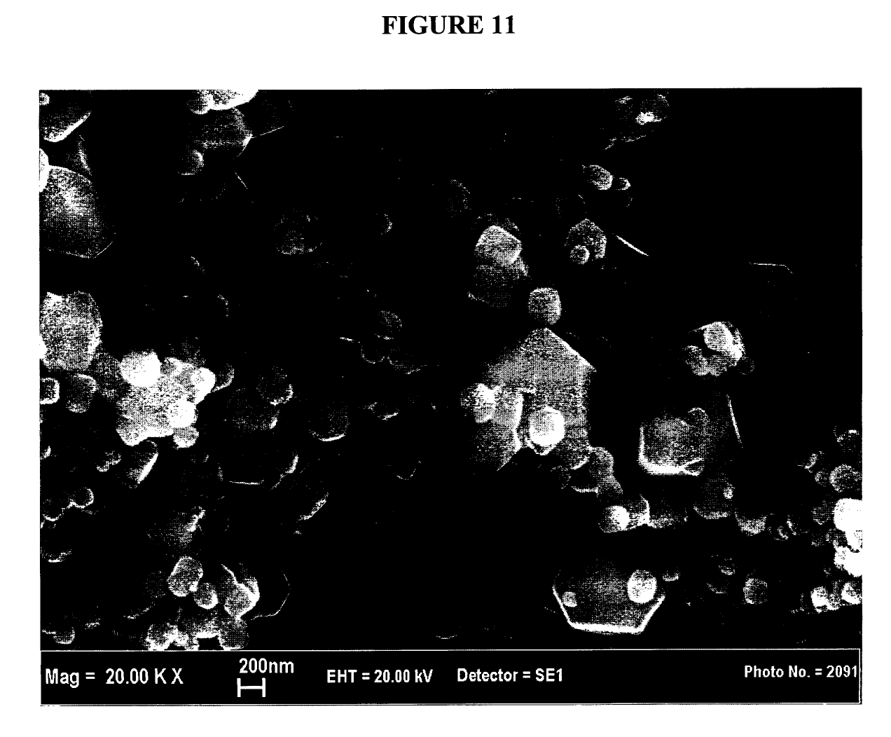

As presented in Table 1, the volume particle size distribution determined by sedimentation shows dᵥ₅₀ of 594 nm with a dᵥ₁₀ and dᵥ₉₀ of 248 nm and 919 nm respectively. FIG. 11 is a SEM micrograph showing particles with a predominantly polyhedral shape and a very wide primary particle size distribution. The c/a ratio could not be calculated as the XRD peak was too difficult to fit accurately due to the wide particle size distribution. The density is 5.871 (+0.002) g.cm⁻³ and the specific surface area is 4.7 m²/g (see Table 2). The Ba/Ti ratio equals 1.00. The powder contains 71 ppm of sodium after 19 hours but when the treatment is only performed for 6 hours 2000 ppm of sodium is detected. Finally, thermogravimetric analysis shows a weight loss of 0.10% in the range 200 to 500° C. attributed to the presence of hydroxyls in the barium titanate structure. Despite its high density, this powder shows a much wider particle size distribution than the powders produced using our 2-step process as well as 6% of particles larger than 1 μm.

### Comparative Example 10—One-Step Followed by Post Heat Treatment

Two grams of barium titanate produced according to the procedure described in Example 1a were treated for 1 hour in a pre-heated furnace at 600° C. The powder was then characterized.

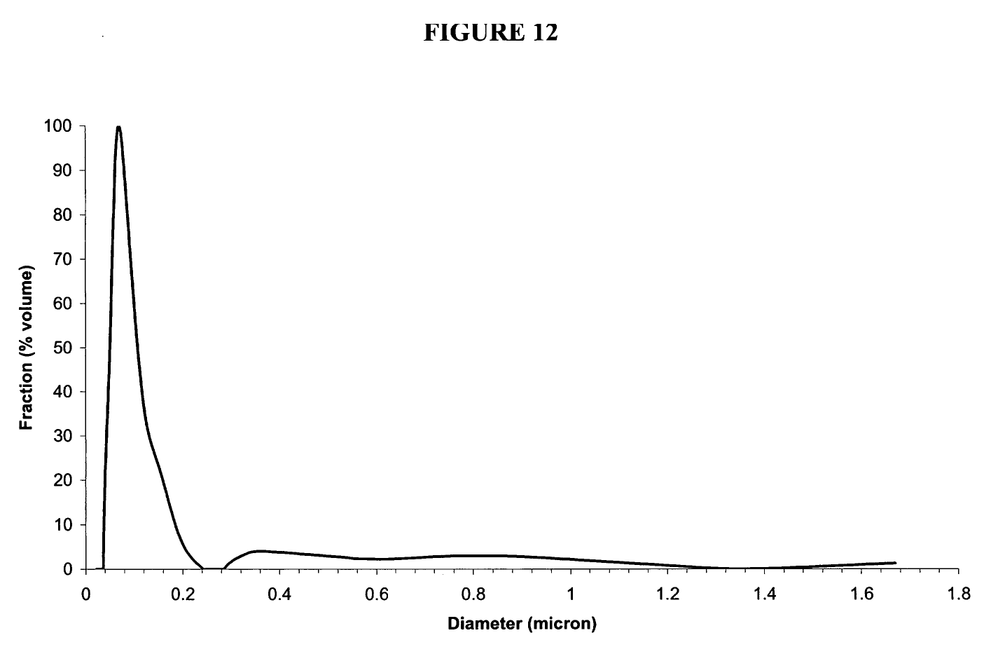

As presented in Table 1 and illustrated by FIG. 12, the volume particle size distribution determined by sedimentation shows dᵥ₅₀ of 112 nm with a dᵥ₁₀ and dᵥ₉₀ of 57 nm and 1068 nm respectively with 13% of particles larger than 1 μm. The density is only 5.22 (±0.01) g.cm⁻³ and the specific surface area is 23 m²/g (see Table 2). Thermogravimetric analysis shows a weight loss of 0.45% in the range 200 to 500° C. attributed to the presence of residual hydroxyls in the barium titanate structure. Despites the low weight loss attributed to the residual hydroxyls, this particle size distribution of this powder shows 13% of particles larger than 1 μm.

### Example 11—Ceramic Body

The barium titanate powder prepared according to the method of Example 1a followed by Example 4 was used to prepare a ceramic body. The powder was used to make cylindrical rods 8-9.5 mm in diameter by isostatic pressing at pressures between 1.15-108 and 1.5-108 Pa. These rods were sintered at different temperatures for a fixed time. Discs approximately 1 mm thick were cut from the rods, flat parallel faces were ground with emery and gold electrodes were evaporated onto them. The resulting capacitor has satisfactory properties.

### Example 12—Production of MLCC

The same barium titanate powder was mixed with dopants and then with an aqueous solution of polyvinyl alcohol binder to prepare a slurry. Mixing and milling were carried out in water, using a ball mill with 2 mm diameter stabilized zirconia balls. Ceramic green foils were tape-casted. After sieve printing of Ni electrodes the foils were stacked, laminated and cut to form MLCCs of the size 1206 with 150 active dielectric layers. The MLCCs were fired at 1300° C. for 2 h in a reducing atmosphere of moist nitrogen and hydrogen. The fired chips were terminated with Cu electrodes and then electroplated with nickel and tin to provide surface mountable MLCCs. The resulting capacitors have satisfactory properties.

### Tables

Various characteristics of the Examples are shown in Tables 1 to 7. Table 8 compares characteristics of powders prepared according to the inventive process with those of EP 1 205 440.

TABLE 1

| | dᵥ₁₀ | dᵥ₅₀ | dᵥ₈₄ | dᵥ₁₀₀ | dᵥ₁₀₀ | | | |
|---|---|---|---|---|---|---|---|---|
| | (nm) | (nm) | (nm) | (nm) | (nm) | Span | σ_{g} | % > 1 μm |
| Example | 48 | 75 | — | 116 | — | 0.91 | — | 0 |
| 1a | | | | | | | | |
| Example | 101 | 155 | — | 252 | — | 0.97 | — | 0 |
| 1b | | | | | | | | |
| Example | 71 | 106 | 139 | 151 | 250 | 0.75 | 0.76 | 0 |
| 2 | | | | | | | | |
| Example | 85 | 130 | 172 | 189 | 365 | 0.80 | 0.76 | 0 |
| 3 | | | | | | | | |
| Example | 152 | 187 | 219 | 229 | 265 | 0.40 | 0.85 | 0 |
| 4 | | | | | | | | |
| Example | 105 | 154 | 200 | 217 | 350 | 0.73 | 0.77 | 0 |
| 5 | | | | | | | | |
| Example | 113 | 176 | 230 | 248 | 380 | 0.77 | 0.77 | 0 |
| 6 | | | | | | | | |
| Example | 117 | 155 | — | 205 | — | 0.57 | — | 0 |
| 7 | | | | | | | | |
| Example | 147 | 214 | — | 297 | — | 0.70 | — | 0 |
| 8 | | | | | | | | |
| Example | 248 | 594 | — | 919 | — | 1.13 | — | 6 |
| 9 | | | | | | | | |
| Example | 57 | 112 | — | 1068 | — | 9.00 | — | 13 |
| 10 | | | | | | | | |

Table 1 presents the characteristics of the volume particle size distributions determined by sedimentation. Examples 2 to 8 prepared according to the described novel method show median volume diameter dᵥ₅₀ in the range 0.106 to 0.214 μm, a span in the range 0.40 to 0.91, a geometric standard deviation σ_{g} in the range 0.76 to 0.85 and no agglomerates above 1 μm.

Table 2 presents the density and specific surface area, and the BET diameter d_{BET} and the factor of agglomeration F_{AG} calculated using those data are also presented. Examples 2 to 8 prepared according to the described novel method show a density in the range 5.58 to 5.73 g.cm⁻³ corresponding to 92.8 to 95.3% of the intrinsic density of large crystals of barium titanate. Also for those Examples, the F_{AG} is in the range 1.6 to 2.1.

TABLE 2

| | | Specific | | |
|---|---|---|---|---|
| | Density | surface area | | |
| Examples | (g · cm−³) | (m² · g⁻¹) | d_{BET} (nm) | F_{AG} |
| Example 1a | 5.0 | — | — | — |
| Example 1b | 5.0 | — | — | — |
| Example 2 | 5.60 (±0.09) | — | — | — |
| Example 3 | 5.58 (±0.10) | — | — | — |
| Example 4 | 5.73 (±0.06) | 11.6 | 90 | 2.1 |
| Example 5 | 5.71 (±0.01) | 12.1 | 87 | 1.8 |
| Example 6 | 5.67 (±0.05) | 10.5 | 101 | 1.7 |
| Example 7 | 5.65 (±0.01) | 11.3 | 94 | 1.6 |
| Example 8 | 5.668 (±0.005) | 10.2 | 104 | 2.1 |
| Example 9 | 5.871 (±0.002) | 4.7 | 217 | 2.7 |
| Example 10 | 5.22 (±0.01) | 23 | 50 | 2.2 |

Table 3 presents the value of weight losses attributed to removal of hydroxyls as measured by thermogravimetric (TGA) analysis, the c/a ratios and the sodium concentrations. The weight losses attributed to removal of hydroxyls vary between 0.67 and 1.0% depending upon the parameters of the hydrothermal post-treatment. The c/a ratios of Examples 2 to 8 all correspond to a tetragonal structure.

Table 4 exhibits the number particle size distribution defined from image analysis of SEM micrographs. The median number diameter dₙ₅₀ for Examples 2 to 8 is in the range 0.082 to 0.105 μm, while the corresponding span is in the range 0.29 to 0.43 and the geometric standard deviation σ_{g} is in the range 0.84 to 0.92.

TABLE 3

| | TGA | | |
|---|---|---|---|
| | (200 to 500° C.) | XRD | |
| Examples | Wt % | c/a | Na (ppm) |
| Example 1a | 4.2 | 1.00 | 500 |
| Example 1b | — | 1.00 | — |
| Example 2 | 0.8 | 1.002 | 34 |
| Example 3 | 0.7 | 1.006 | 26 |
| Example 4 | 0.7 | 1.007 | 31 |
| Example 5 | 0.8 | 1.006 | 65 |
| Example 6 | 0.72 | 1.006 | 106 |
| Example 7 | 1 | 1.002 | 228 |
| Example 8 | 0.67 | 1.005 | 104 |
| Example 9 | 0.1 | • | 71 |
| Example 10 | 0.45 | 1.00 | ˜500 |

• The c/a ratio was not calculated: the XRD peak was too difficult to fit accurately due to the wide particle size distribution.

TABLE 4

| | dₙ₁₀ | dₙ₂₅ | dₙ₅₀ | dₙ₇₅ | dₙ₈₄ | dₙ₉₀ | dₙ₁₀₀ | | | |
|---|---|---|---|---|---|---|---|---|---|---|
| | nm | nm | nm | nm | nm | nm | nm | Span | σ_{g} | QR |
| Example | 68 | 75 | 82 | 91 | 96 | 99 | 133 | 0.38 | 0.85 | 1.21 |
| 2 | | | | | | | | | | |
| Example | 76 | 82 | 92 | 102 | 106 | 112 | 200 | 0.39 | 0.87 | 1.24 |
| 3 | | | | | | | | | | |
| Example | 80 | 86 | 96 | 108 | 114 | 118 | 144 | 0.40 | 0.84 | 1.26 |
| 4 | | | | | | | | | | |
| Example | 74 | 82 | 94 | 103 | 106 | 110 | 122 | 0.38 | 0.89 | 1.26 |
| 5 | | | | | | | | | | |
| Example | 76 | 86 | 98 | 106 | 111 | 114 | 167 | 0.39 | 0.88 | 1.23 |
| 6 | | | | | | | | | | |
| Example | 82 | 91 | 98 | 105 | 107 | 110 | 144 | 0.29 | 0.92 | 1.15 |
| 7 | | | | | | | | | | |
| Example | 83 | 92 | 105 | 115 | 122 | 128 | 178 | 0.43 | 0.86 | 1.25 |
| 8 | | | | | | | | | | |
| Example | 140 | 176 | 238 | 331 | 390 | 440 | 1000 | 1.26 | 0.61 | 1.88 |
| 9 | | | | | | | | | | |

TABLE 5

| | dᵥ₁₀ | dᵥ₂₅ | dᵥ₅₀ | dᵥ₇₅ | dᵥ₈₄ | dᵥ₉₀ | dᵥ₁₀₀ | | | |
|---|---|---|---|---|---|---|---|---|---|---|
| | (nm) | (nm) | (nm) | (nm) | (nm) | (nm) | (nm) | Span | σ_{g} | QR |
| Example | 90 | 99 | 109 | 120 | 125 | 132 | 165 | 0.39 | 0.87 | 1.21 |
| 2 | | | | | | | | | | |
| Example | 101 | 111 | 124 | 142 | 160 | 178 | 248 | 0.62 | 0.78 | 1.28 |
| 3 | | | | | | | | | | |
| Example | 104 | 115 | 130 | 142 | 148 | 154 | 208 | 0.38 | 0.88 | 1.23 |
| 4 | | | | | | | | | | |
| Example | 100 | 112 | 124 | 133 | 136 | 140 | 156 | 0.32 | 0.91 | 1.19 |
| 5 | | | | | | | | | | |
| Example | 104 | 117 | 129 | 140 | 146 | 154 | 208 | 0.39 | 0.88 | 1.20 |
| 6 | | | | | | | | | | |
| Example | 104 | 117 | 129 | 140 | 146 | 154 | 194 | 0.39 | 0.88 | 1.20 |
| 7 | | | | | | | | | | |
| Example | 112 | 126 | 140 | 157 | 168 | 180 | 220 | 0.49 | 0.83 | 1.25 |
| 8 | | | | | | | | | | |
| Example | 254 | 340 | 506 | 698 | 848 | 978 | 1000 | 1.43 | 0.60 | 2.05 |
| 9 | | | | | | | | | | |

TABLE 6

| | dᵥ₁₀ | dᵥ₅₀ | dᵥ₉₀ |
|---|---|---|---|
| Examples | ratio | ratio | ratio |
| Example 2 | 0.8 | 1.0 | 1.1 |
| Example 3 | 0.8 | 1.0 | 1.1 |
| Example 4 | 1.5 | 1.4 | 1.5 |
| Example 5 | 1.1 | 1.2 | 1.6 |
| Example 6 | 1.1 | 1.4 | 1.6 |
| Example 7 | 1.1 | 1.2 | 1.3 |
| Example 8 | 1.3 | 1.5 | 1.7 |
| Example 9 | 1.0 | 1.2 | 0.9 |

TABLE 7

| | Shape of primary | | Span |
|---|---|---|---|
| Examples | particles | Structure | (sedimentation) |
| Example 1a | sphere | Cubic | 0.91 |
| Example 1b | sphere | Cubic | 0.97 |
| Example 2 | 85% cube | Tetragonal | 0.75 |
| Example 3 | 85% cube | Tetragonal | 0.80 |
| Example 4 | 90% cube | Tetragonal | 0.40 |
| Example 5 | 86% cube | Tetragonal | 0.73 |
| Example 6 | 96% cube | Tetragonal | 0.77 |
| Example 7 | 91% cube | Tetragonal | 0.57 |
| Example 8 | 87% cube | Tetragonal | 0.70 |
| Example 9 | polyhedra | Undetermined | 1.13 |
| Example 10 | generally sphere | Cubic | 9.00 |

Table 5 exhibits the volume particle distribution defined from image analysis of SEM micrographs. The median volume diameter dᵥ₅₀ for examples 2 to 8 is in the range 0.109 to 0.140 μm.

Table 6 compares the dᵥ₁₀, dᵥ₅₀ and dᵥ₉₀ ratios by sedimentation/image analysis. As shown in Table 6, the ratios between the sedimentation dᵥ₅₀ and the image analysis dᵥ₅₀ is in the range 1.0 to 1.5, confirming the absence of agglomerates made up of numerous (more than 8) primary particles.

Table 7 presents the shape observed for each example, including the amount in % of particles of cube-like shape encountered for Examples 2 to 8. All those examples also show a tetragonal structure and a span of the particle size distributions (determined by sedimentation) smaller than 1.

Table 8 compares various characteristics of powders prepared according to the method of this invention with those of EP 1 205 440, highlighting notably the different particle shapes, and the conversion from cubic structure obtained after a rapid low-temperature first stage reaction to tetragonal by the solvo- or hydrothermal second stage below 400° C. according to the invention, compared to conversion from cubic structure obtained after ageing and hydrothermal treatment in EP 1 205 440 followed by calcination at 500-1000° C. to obtain tetragonal structure.

TABLE 8

| Characteristics | EP 1,205,440 | This invention |
|---|---|---|
| Average size or dₙ₅₀ (μm) | 0.05-0.5 μm | 0.005 to 0.25 μm |
| by image analysis | | |
| Geometric standard | σ_{g} ≧ 0.70 | 0.75 ≦ σ_{g} < 1 |
| deviation (σ_{g} = dₙ₅₀/dₙ₈₄) of | | |
| particle size distribution | | |
| determined by image | | |
| analysis | | |
| Particle shape | Spherical with sphericity | Isotropic and facetted |
| | (maximum diam/minimum | individual particle shape, |
| | diameter) from 1.0 to 1.4 | in particular a cube-like |
| | | shape |
| Crystal structure | Cubic structure after | Cubic structure after rapid |
| | ageing and hydrothermal | low temperature first stage, |
| | treatment, converted to | converted to tetragonal by |
| | tetragonal by calcination at | a second stage below |
| | 500-1000° C. | 400° C. |
| c/a | Without coating: | 1.002 < c/a < 1.008 |
| | 1.005 < c/a < 1.014 | |
| | With coating: | |
| | 1.007 < c/a < 1.016 | |
| Specific Surface Area | 2-20 | 2-30 |
| (m²/g) | | |
| Density | High denseness after | High density after solvo- or |
| | calcining | hydrothermal treatment, |
| | | corresponding to at least |
| | | 90% of the intrinsic density |
| | | of a large crystal |

All of the Examples above are described on laboratory scale. To scale up for industrial production, the powder of the first step of the process can be prepared in an SFTR apparatus with multiple reaction tubes, however while maintaining suitable small segmented reaction volumes. On the other hand, the hydrothermal post treatment can be scaled up by increasing the size of the reactor/autoclave or by using a continuous hydro- or solvothermal apparatus. This opens new possibilities for producing ultrafine barium titanate on a large scale, by producing the ultrafine particles of defined characteristics but low density from small reaction volumes in the first stage, then converting large amounts of the low density ultrafine particles into high density ultrafine particles during the second stage.

1. A method of producing a powder of barium titanate BaTiO₃ including solid solutions and doped compounds thereof, which powder is composed of non agglomerated ultrafine particles of tetragonal barium titanate of high density corresponding to at least 90% of the intrinsic density of a large crystal of the corresponding compound, whose individual particles have an isotropic shape of given aspect ratio all particles being smaller than 1 micron and having a particle size distribution width measured by sedimentation* having a span (dᵥ₉₀−dᵥ₁₀)/dᵥ₅₀ less than 1, where dᵥ₉₀ refers to a value such that 90% of the powder volume is made of smaller sizes, dᵥ₁₀ refers to a value such that 10% of the powder volume is made of smaller sizes, and dᵥ₅₀ refers to the volume median diameter such that 50% of the powder volume is made of smaller sizes, and wherein the ratio of Ba:Ti including their substitutents and dopants is very close to ideal stoichiometry, the method comprising:
*All measurements of particle size distributions by sedimentation in the description and claims are made using a BI-XDCP Particle Sizer instrument.
(a) carrying out a first stage reaction between reactants composed of compounds of barium and titanium and optional selected substitutents and dopants by preparing at room temperature a liquid-containing reaction mixture and subjecting the reaction mixture to reaction temperatures in the range 80° C., preferably 85° C., to boiling temperature, at a pressure of 1 bar, for a reaction period up to 20 minutes to produce a powder of barium titanate composed of non-agglomerated ultrafine particles having a shape of said given aspect ratio and cubic structure, of low density corresponding at most to 90% of said intrinsic density, all particles being smaller than 1 micron and having a particle size distribution span (dᵥ₉₀−dᵥ₁₀)/dᵥ₅₀ less than 1, and wherein the ratio of Ba:Ti including their substitutents and dopants is very close to ideal stoichiometry; and
(b) subjecting the powder of cubic structure produced in step (a) to a second stage solvothermal post treatment at a temperature less than 400° C. to convert the particles of low density to ultrafine particles of increased density corresponding to at least 90% of said intrinsic density, and converting the isotropic, cubic-structure particles to tetragonal barium titanate particles while maintaining said given aspect ratio and maintaining the size of all particles below 1 micron, the particle size distribution span (dᵥ₉₀−dᵥ₁₀)/dᵥ₅₀ below 1, and the ratio of Ba:Ti including their substitutents and dopants very close to ideal stoichiometry.

2. The method of claim 1, wherein the produced mixed oxide is a solid solution of composition Ba₍₁₋ₓ₎AₓTi_{(1-y)}B_{y}O₃, where the mole fractions x and y are each in the range between 0 and 1, preferably larger than 0.03, A is at least one divalent metal selected from calcium, cadmium, europium, magnesium, lead, radium, strontium and zinc and B is least one tetravalent metal selected from cerium, cobalt, iron, hafnium, molybdenum, lead, praseodymium, plutonium, ruthenium, tin, thorium, uranium, vanadium and zirconium.

3. The method of claim 2, wherein the produced powder is a doped solid solution of composition Ba₍₁₋ₓ₋ₐ₎AₓXₐTi_{(1-y-b)}B_{y}Y_{b}O₃, where the mole fractions x and y are in the range of 0 to 1, preferably larger than 0.03, the mole fractions a and b are in the range 0 to 0.2, preferably below 0.05, A represents one or more of said divalent metals, B represents one or more of said tetravalent metals, and X and Y each represent one or more other metals selected from the group consisting of calcium, lanthanum, rare earth elements, lithium, magnesium, yttrium, niobium, tantalum, gallium, molybdenum, tungsten, manganese, copper, iron, cobalt, nickel, chromium, zinc, aluminium, silicon, antimony, lead, bismuth, boron and mixtures thereof.

4. The method of claim 2, wherein the produced powder is a doped barium titanate Ba₍₁₋ₐ₎XₐTi_{(1-b)}Y_{b}O₃, where the mole fractions a and b are in the range between 0 to 0.2, preferably below 0.05, and X and Y each represent one or more metals selected from the group consisting of calcium, lanthanum, rare earth elements, lithium, magnesium, yttrium, niobium, tantalum, gallium, molybdenum, tungsten, manganese, copper, iron, cobalt, nickel, chromium, zinc, aluminium, silicon, antimony, lead, bismuth, boron and mixtures thereof.

5. The method of claim 3 or 4, wherein the dopant elements X and/or Y are introduced as reagents in step (a) to ensure homogeneous dopant distribution within the structure, and/or as reagents in step (b) to ensure a gradient of dopant concentration from the particle surface to the particle core.

6. The method of claim 1, wherein the produced powder is undoped and non-substituted barium titanate BaTiO₃.

7. The method of any preceding claim, wherein the tetragonal particles produced in step (b) have an isotropic and facetted individual particle shape, in particular a cube-like shape.

8. The method of claim 7, wherein the powder produced in step (b) has more than 50% and preferably more than 80 or 90% of cube-like shape tetragonal particles.

9. The method of claim 7 or 8, wherein the powder produced in step (b), or after a subsequent heat treatment, has 5-95% of individual particles with an isotropic and facetted individual particle shape, in particular a cube-like shape.

10. The method of claim 7, 8 or 9, wherein the cubic-structure particles produced in step (a) have a generally spherical shape.

11. The method of any preceding claim, wherein step (b) is followed by a heat treatment during which part or all of the particles change shape.

12. The method of claim 11, wherein after the heat treatment 5-80%, 5-50% or 5-20% of the individual particles retain an isotropic facetted shape in particular a cube-like shape.

13. The method of any one of claims 1 to 12, wherein step (a) is performed by preparing a dispersion, emulsion, suspension or gel of the reaction mixture at room temperature in particular by mixing a mixture of salts, alkoxides or hydroxides of barium and titanium optionally with NaOH, KOH, TMAH or ammonia.

14. The method of claim 13 when depending on claim 5, wherein dopant reagent(s) is/are introduced to the dispersion, emulsion, suspension or gel in the form of salts, alkoxides, organic compounds or hydroxides of the dopant elements to produce the doped solid solution.

15. The method of any preceding claim, wherein step (a) is performed using a continuous reactor or a reactor that discontinuously processes reaction volumes up to 1 litre.

16. The method of claim 15, wherein step (a) is performed using a discontinuous fed-batch reactor of up to 1 litre reaction volume, or using a continuous mixed suspension-mixed product removal (MSMPR) reactor of up to 1 litre residence volume.

17. The method of claim 15, wherein step (a) is performed using a tubular reactor.

18. The method of claim 17, wherein step (a) is performed using a Segmented Flow Tubular Reactor wherein reaction volumes are separated by a segmenting fluid that is not miscible with the reaction mixture.

19. The method of any preceding claim, wherein step (b) is performed by adding the barium titanate powder produced in step (a) to an aqueous solution at pH above 9 or to a non-aqueous solution of at least one metal compound to produce a suspension, and subjecting the suspension to a solvothermal post treatment at a pressure above 1 bar and a temperature between 100° C. and 400° C., preferably in the range 200-350° C., for a residence period of 2 to 20 hours.

20. The method of any preceding claim, wherein a large quantity of low density barium titanate is produced by repeating step (a) with small volumes of the reaction mixture that each yield small quantities of the low density barium titanate that are collected to form said large quantity, and subjecting said large quantity of low density barium titanate to the second stage solvothermal post treatment.

21. The method of any preceding claim, wherein the span of particle size distribution is maintained or decreased from step (a) to step (b), with a shift of the particle size distribution (dᵥ₁₀, dᵥ₅₀, dᵥ₉₀) towards higher sizes after the solvothermal post-treatment of step (b).

22. The method of any preceding claim wherein in step (a) the reaction mixture is heated from room temperature to the reaction temperature in less than 3 minutes, optionally with stirring.

23. The method of any preceding claim, wherein step (b) is performed using a hydrothermal apparatus.

24. A powder of barium titanate BaTiO₃ including solid solutions and doped compounds thereof, that is obtainable by the method of any preceding claim, which powder is composed of non agglomerated ultrafine particles of tetragonal barium titanate of high density corresponding to at least 90% of the intrinsic density of a large crystal of the corresponding compound, of which at least 50%, preferably at least 80 or 90% of the individual particles have an isotropic facetted shape, in particular a cube-like shape, all particles being smaller than 1 μm and having a particle size distribution measured by sedimentation having a span (dᵥ₉₀−dᵥ₁₀)/dᵥ₅₀ less than 1, where dᵥ₉₀ refers to a value such that 90% of the powder volume is made of smaller sizes, dᵥ₁₀ refers to a value such that 10% of the powder volume is made of smaller sizes, and dᵥ₅₀ refers to the volume median diameter such that 50% of the powder volume is made of smaller sizes, and wherein the ratio of Ba:Ti including their substitutents and dopants is very close to ideal stoichiometry.

25. A powder of barium titanate BaTiO₃ including solid solutions and doped compounds thereof, that is obtainable by the method of any of claims 1 to 24, which powder is composed of ultrafine particles, wherein no agglomerates are bigger than 1 μm, preferably no bigger than 0.8 μm, having:
(a) a primary particle size distribution determined from image analysis with a median number diameter dₙ₅₀ comprised in the range 0.005 to 0.250 μm, a maximum primary particle size of 0.5 μm, a number size distribution span (dₙ₉₀−dₙ₁₀)/dₙ₅₀ of 0.8 and below, and a geometric standard deviation σ_{g} (=dₙ₅₀/dₙ₈₄) from 0.75 to <1,
(b) a particle size distribution measured by sedimentation with a median volume diameter dᵥ₅₀ comprised in the range 0.01 to 0.5 μm, without any hard agglomerate bigger than 0.8 μm, a volume size distribution span (dᵥ₉₀−dᵥ₁₀)/dᵥ₅₀ less than 0.95 and a geometric standard deviation σ_{g} (=dᵥ₅₀/dᵥ₈₄) from 0.70 to <1,
(c) a factor of agglomeration (F_{AG}=dᵥ₅₀/d_{BET}) smaller than 2.1, preferably smaller than 1.6,
(d) a ratio between the sedimentation dᵥ₅₀ and the image analysis dᵥ₅₀ in the range 1.0 to 1.5,
(e) a tetragonal structure,
(f) a density of at least 90% of the intrinsic density of a large crystal of the corresponding compound,
(g) a hydroxyl content less that 1 wt %, and
(h) a ratio of Ba:Ti including their substitutents and dopants equal to 1.00 plus or minus 1 atomic percent.

26. The powder of claim 25 wherein at least 50%, preferably 80%, more preferably 90% of individual particles have an isotropic and facetted individual particle shape, in particular a cube-like shape.

27. The powder of claim 25 or 26 which is undoped and non-substituted tetragonal barium titanate BaTiO₃ of which at least 80%, preferably at least 90%, of the individual particles have a cube-like shape.

28. A method of producing a body, in particular a ceramic body, comprising producing barium titanate powder by the method of any one of claims 1 to 23, and forming the powder into a body with or without binding agents, in particular by the application of pressure and heat separately or together.

29. The method of claim 24 wherein the body is a capacitor.

30. A method of producing a film, coating or layer of barium titanate, comprising producing barium titanate powder by the method of any one of claims 1 to 28, and forming the powder into a film, coating or layer by tape casting, doctor blading, screen-printing, electrodeposition, dip coating, spin coating or thermal spraying and optionally applying heat to the as-produced film, coating or layer.

31. The method of claim 30 wherein the powder is formed as a coating on a substrate or a layer in a multilayer structure.

32. The method of claim 34 wherein the barium titanate powder is formed as a non-supported film.

33. A method of producing a dispersion, suspension, emulsion or gel of a barium titanate powder in a fluid medium, comprising producing barium titanate powder by the method of any one of claims 1 to 28, and maintaining the particles in suspension at the end of step (b) and/or mixing the produced powder with the fluid medium to produce the dispersion, suspension, emulsion or gel.
